(19) United States
(12) Patent Application Publication
(10) Pub. No.: US 2017/0169530 A1
(43) Pub. Date: Jun. 15, 2017

(54) CURIOUS QUOTIENT SYSTEM AND METHOD

(71) Applicant: Curious.com, Inc., Menlo Park, CA (US)

(72) Inventors: Justin Shelby Kitch, Palo Alto, CA (US); John Paul Tokash, Pacifica, CA (US); Thai Duc Bui, Los Altos, CA (US)

(73) Assignee: Curious.com, Inc., Menlo Park, CA (US)

(21) Appl. No.: 15/376,652

(22) Filed: Dec. 12, 2016

Related U.S. Application Data
(60) Provisional application No. 62/265,426, filed on Dec. 10, 2015.

(51) Int. Cl. G06Q 50/20; G09B 5/06; G09B 7/00; G06Q 50/24

(52) U.S. Cl. CPC G06Q 50/205; G06Q 50/24; G09B 5/06; G09B 7/00; G09B 19/00

(57) ABSTRACT

A curiosity quotient computer system and method includes a knowledge acquirer database with records such as a knowledge acquirer identifier, an age, and a daily amount of knowledge acquirer time commitment for each knowledge acquirer. The system also includes an assessment database with records related to subject matter assessments including assessments for a first and a second subject matter category. A focus assessment database includes records related to the knowledge acquirer's focus area. A weighting generator at least in part generates weights based on the assessment records and a graphical interface conveys a rotatable wheel display to the knowledge acquirer. The system also includes logic for using the weights and the knowledge acquirer's interest level, experience, topics of interests and focus area to provide a list of subject matter content.

### CLAIM OF PRIORITY

The present application claims priority from U.S. Provisional Patent Application No. 62/265,426, entitled Curiosity Quotient Engine, filed Dec. 10, 2015, said application is hereby incorporated by reference as if fully set forth herein.

### BACKGROUND

The present disclosure relates generally to computer information and communication systems and methods and more specifically to computer information and communication systems and methods for facilitating knowledge acquisition and building the curiosity quotient of knowledge acquirers.

Many influential studies consistently show that people who stretch their brains and continue to learn are consistently happier, are more successful and live longer. When individuals decide to acquire knowledge, they engage in a process to determine what new things to learn and what is right for them. In essence, such people are building their CQs (Curiosity Quotient).

However, given the ubiquity of digital content, online knowledge acquisition and the multitude of available libraries for knowledge acquisition, many individuals are faced with a conundrum as to what subject matter category to focus on. Many individuals cannot easily reach such determination until perhaps they become familiar with and understand what is available to them and develop personal preferences for such subject matter.

Some individuals enter the knowledge acquisition selection process with already developed preferences for some topics or attributes and with some preferences not yet found. Some already formed preferences may also change after the knowledge acquisition process begins. Thus, the decision-making process may involve reading and examining potentially large amounts of information until a determination is made. Even when a determination is made, the tracking of a knowledge acquirer's progress can be challenging. Content owners are also faced with a similar conundrum, not knowing what subject matter or categories of subject matter to provide to their users.

It is within the aforementioned context that a need for the present disclosure has arisen. Thus, there is a need to address one or more of the foregoing disadvantages of conventional systems and methods, and the present disclosure meets this need.

### BRIEF SUMMARY

Various aspects of a curiosity quotient system and method can be found in exemplary embodiments of the present disclosure.

In one aspect, the curiosity quotient system is a networked computer system that includes a knowledge acquirer database having records related to knowledge acquirers, of a plurality of such knowledge acquirers. Here, a record includes, for each knowledge acquirer, an identifier, an age, and a daily amount of knowledge acquisition time that is committed to by the knowledge acquirer.

The system also includes an assessment database with records related to subject matter assessments for various predetermined subject matter categories. Here, a subject matter assessment record includes a first and a second subject matter category having answers and corresponding questions about the knowledge acquirer's interest level in a subject matter, the knowledge acquirer's experience with the first subject matter category; and topics of the first subject matter that are of interest to the knowledge acquirer.

The system also includes a focus assessment database with records related to the knowledge acquirer's focus area. Here, a knowledge acquirer's focus area record might include a single selected subtopic area that the knowledge acquirer wishes to focus on. The single selected subtopic area may be selected from displayed subtopic areas of the predetermined subject matter categories. The system also comprises a weighting generator for generating weights for the knowledge acquirer's interest level, experience, topics of interests and focus area, wherein the weighting generator at least in part generates weights based on whether a focus area is selected, previously viewed subject matter, highly rated content, complexity, experience level, for example.

A graphical interface for conveying a rotatable wheel display to the knowledge acquirer is also included. The rotatable wheel display is segmented into same-sized sectors. Each same-sized section is bounded by a circumferential arc of the rotatable wheel. The same-sized sectors include a first sector for the first subject matter category and a second even sector for the second subject matter category.

Here, the position of a circumferential arc is based on the weights generated for the knowledge acquirer's interest level, experience, topics of interests and focus area sectors. A higher weighting moves the circumferential arc beyond the circumference of the rotatable wheel and a lower weighting moves the circumferential arc before the circumference of the rotatable wheel. The system includes logic for using the weights and the knowledge acquirer's interest level, experience, topics of interests and focus area to provide a list of subject matter content for viewing.

In another embodiment, a computer implemented method includes creating records for a user database comprising records related to knowledge acquirers, of a plurality of users, a record including for each user, a user identifier, an age, and a daily amount of knowledge acquirer time commitment; creating subject matter assessments for an assessment database comprising records related to subject matter assessments for a plurality of predetermined subject matter categories, wherein a subject matter assessment record includes for each knowledge acquirer, a plurality of subject matter categories namely a first subject matter category having at least an answer and a question about the knowledge acquirer's interest level in a subject matter, the knowledge acquirer's experience with the first subject matter category; and topics of the first subject matter that are of interest to the knowledge acquirer; and a second subject matter category having at least an answer and a question about the knowledge acquirer's interest level in the second subject matter category, the knowledge acquirer's experience with the second subject matter; and topics of the second subject matter that are of interest to the knowledge acquirer.

The method also includes creating knowledge acquirer's focus area assessments for a focus assessment database comprising records related to the knowledge acquirer's focus area, wherein a knowledge acquirer's focus area record includes a single selected subtopic area that the knowledge acquirer wishes to focus on, wherein said single selected subtopic area is selected from displayed subtopic areas of the plurality of predetermined subject matter categories; generating weights for the knowledge acquirer's interest level, experience, topics of interests and focus area; presenting a graphical interface for conveying a rotatable wheel display to the knowledge acquirer, wherein the rotatable wheel display is segmented into a plurality of same-sized sectors, each bounded by a circumferential arc of the rotatable wheel, the same-sized sectors including a first sector that corresponds to the first subject matter category and a second even sector that corresponds to the second subject matter category, wherein the position of a circumferential arc is based on the weights generated for the knowledge acquirer's interest level, experience, topics of interests and focus area sectors, wherein a higher weighting moves the circumferential arc beyond the circumference of the rotatable wheel and a lower weighting moves the circumferential arc before the circumference of the rotatable wheel; and using the weights and the knowledge acquirer's interest level, experience, topics of interests and focus area to provide a list of subject matter content for viewing.

In another embodiment, a non-transitory computer readable medium comprises instructions executed by a processor for: creating records for a user database comprising records related to knowledge acquirers, of a plurality of users, a record including for each user, a user identifier, an age, and a daily amount of knowledge acquirer time commitment; creating subject matter assessments for an assessment database comprising records related to subject matter assessments for a plurality of predetermined subject matter categories, wherein a subject matter assessment record includes for each knowledge acquirer, a plurality of subject matter categories namely a first subject matter category having at least an answer and a question about the knowledge acquirer's interest level in a subject matter, the knowledge acquirer's experience with the first subject matter category; and topics of the first subject matter that are of interest to the knowledge acquirer; and a second subject matter category having at least an answer and a question about the knowledge acquirer's interest level in the second subject matter category, the knowledge acquirer's experience with the second subject matter; and topics of the second subject matter that are of interest to the knowledge acquirer.

The non-transitory computer readable medium also comprises instructions executed by a processor for: creating knowledge acquirer's focus area assessments for a focus assessment database comprising records related to the knowledge acquirer's focus area, wherein a knowledge acquirer's focus area record includes a single selected subtopic area that the knowledge acquirer wishes to focus on, wherein said single selected subtopic area is selected from displayed subtopic areas of the plurality of predetermined subject matter categories; generating weights for the knowledge acquirer's interest level, experience, topics of interests and focus area; presenting a graphical interface for conveying a rotatable wheel display to the knowledge acquirer, wherein the rotatable wheel display is segmented into a plurality of same-sized sectors, each bounded by a circumferential arc of the rotatable wheel, the same-sized sectors including a first sector that corresponds to the first subject matter category and a second even sector that corresponds to the second subject matter category, wherein the position of a circumferential arc is based on the weights generated for the knowledge acquirer's interest level, experience, topics of interests and focus area sectors, wherein a higher weighting moves the circumferential arc beyond the circumference of the rotatable wheel and a lower weighting moves the circumferential arc before the circumference of the rotatable wheel; and using the weights and the knowledge acquirer's interest level, experience, topics of interests and focus area to provide a list of subject matter content for viewing.

A further understanding of the nature and advantages of the present disclosure herein may be realized by reference to the remaining portions of the specifications and the attached drawings. Further features and advantages of the present disclosure, as well as the structure and operation of various embodiments of the present disclosure, are described in detail below with respect to the accompanying drawings. In the drawings, the same reference numbers indicate identical or functionally similar elements.

### BRIEF DESCRIPTION OF THE DRAWINGS

FIG. 1 illustrates a curious quotient network system according to an exemplary embodiment of the present disclosure.

FIG. 2 illustrates a broad flow of one implementation of the present disclosure.

FIG. 3 illustrates an assessment process flow according to an exemplary embodiment of the present disclosure.

FIG. 4 illustrates a broad process flow for the rotatable CQ wheel according to an exemplary embodiment of the present disclosure.

FIG. 5 illustrates a broad process flow for providing subject matter content according to an exemplary embodiment of the present disclosure.

FIG. 6 illustrates a homepage screenshot of a curiosity quotient knowledge acquisition system according to an exemplary embodiment of the present invention.

FIG. 7 illustrates a rotatable CQ wheel as might be displayed during assessment according to an exemplary embodiment of the present invention.

FIG. 8 illustrates the rotatable CQ wheel of FIG. 7 as might be further displayed during assessment according to an exemplary embodiment of the present invention.

FIG. 9 illustrates knowledge acquirer assessment according to an exemplary embodiment of the present invention.

FIG. 10 illustrates a knowledge acquirer profiling screenshot according to an exemplary embodiment of the present invention.

FIG. 11 illustrates subject knowledge assessment screenshot for music according to an exemplary embodiment of the present invention.

FIG. 12 illustrates subject knowledge assessment screenshot for music according to an exemplary embodiment of the present invention.

FIG. 13 illustrates subject knowledge assessment screenshot for music according to an exemplary embodiment of the present invention.

FIG. 14 illustrates subject knowledge assessment screenshot for music according to an exemplary embodiment of the present invention.

FIG. 15 illustrates subject knowledge assessment screenshot for music according to an exemplary embodiment of the present invention.

FIG. 16 illustrates subject knowledge assessment screenshot for music according to an exemplary embodiment of the present invention.

FIG. 17 illustrates subject knowledge assessment screenshot for music according to an exemplary embodiment of the present invention.

FIG. 18 illustrates subject knowledge assessment screenshot for play according to an exemplary embodiment of the present invention.

FIG. 19 illustrates subject knowledge assessment screenshot for play according to an exemplary embodiment of the present invention.

FIG. 20 illustrates subject knowledge assessment screenshot for play according to an exemplary embodiment of the present invention.

FIG. 21 illustrates subject knowledge assessment screenshot for work according to an exemplary embodiment of the present invention.

FIG. 22 illustrates subject knowledge assessment screenshot for work according to an exemplary embodiment of the present invention.

FIG. 23 illustrates subject knowledge assessment screenshot for work according to an exemplary embodiment of the present invention.

FIG. 24 illustrates subject knowledge assessment screenshot for mind and body according to an exemplary embodiment of the present invention.

FIG. 25 illustrates subject knowledge assessment screenshot for mind and body according to an exemplary embodiment of the present invention.

FIG. 26 illustrates subject knowledge assessment screenshot for mind and body according to an exemplary embodiment of the present invention.

FIG. 27 illustrates subject knowledge assessment screenshot for relationships according to an exemplary embodiment of the present invention.

FIG. 28 illustrates subject knowledge assessment screenshot for relationships according to an exemplary embodiment of the present invention.

FIG. 29 illustrates subject knowledge assessment screenshot for relationships according to an exemplary embodiment of the present invention.

FIGS. 30, 31 and 32 illustrate subject knowledge assessment screenshots for S.T.E.M. according to an exemplary embodiment of the present invention.

FIGS. 33, 34 and 35 illustrate subject knowledge assessment screenshots for aesthetic according to an exemplary embodiment of the present invention.

FIGS. 36, 37 and 38 illustrate subject knowledge assessment screenshots for aesthetic according to an exemplary embodiment of the present invention.

FIG. 39 illustrates a subject assessment table according to an exemplary embodiment of the present invention.

FIG. 40 illustrates a focus assessment screenshot for according to an exemplary embodiment of the present invention.

FIG. 41 illustrates a focus assessment table according to an exemplary embodiment of the present invention.

FIG. 42 illustrates a rotatable CQ wheel display according to one implementation of the present invention.

FIG. 43 is an expanded wheel display according to one embodiment of the present invention.

FIG. 44 is a daily dose dashboard according to one embodiment of the present invention.

FIG. 45 is a daily dose expanded wheel showing total CQ points according to an exemplary embodiment of the present invention.

FIG. 46 illustrates components of computing device that can be utilized by the present invention.

FIG. 47 illustrates a network environment in which various embodiments of the present invention may be implemented.

### DETAILED DESCRIPTION

Reference will now be made in detail to the embodiments of the disclosure, examples of which are illustrated in the accompanying drawings. While the disclosure will be described in conjunction with the preferred embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth to provide a thorough understanding of the present disclosure. However, it will be obvious to one of ordinary skill in the art that the present disclosure may be practiced without these specific details. In other instances, well-known methods, procedures, components, and circuits have not been described in detail as to not unnecessarily obscure aspects of the present disclosure.

An example of a website for implementing the system and method of the present disclosure is locatable at www.curious.com/learner-engine. The term “website” is generally applicable to a method for downloading/uploading and should not be construed as being limited to content downloaded/uploaded via Internet or HTTP (HyperText Transmission Protocol). Note also that server-performed functionality can also be performed on the client side as well.

The disclosure might be accessible via a Curiosity Quotient app on a mobile device. The term “Curiosity Quotient” or CQ, a numeric designation that can indicate an individual knowledge acquirer's curiosity about the universe of knowledge acquisition. The higher an individual's CQ, the happier the individual is; the individual is also more successful and can easily adapt to complexity. Embodiments of the present disclosure facilitate CQ building.

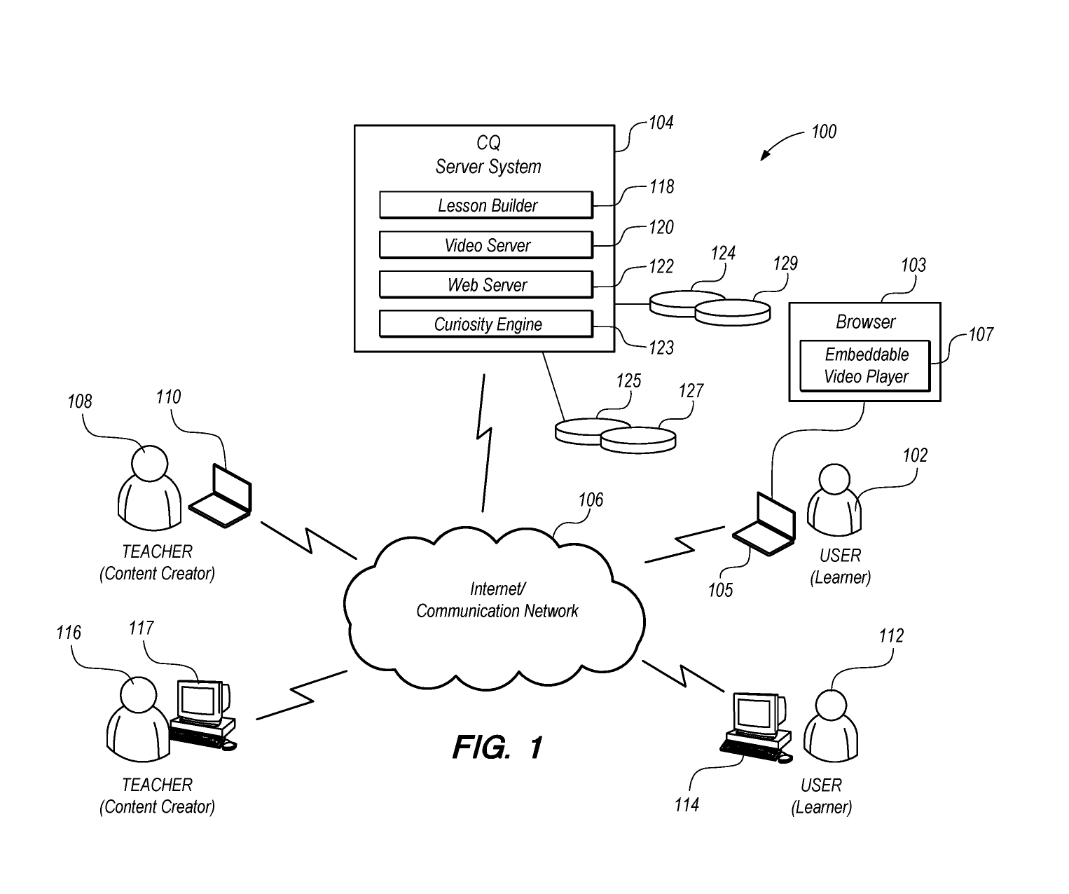

FIG. 1 illustrates curiosity quotient computer network 100 according to an exemplary embodiment of the present disclosure.

In FIG. 1, curiosity quotient computer network 100 comprises, among other components, a knowledge acquirer or user 102 communicably coupled to curiosity quotient server 104 via Internet/communication network 106 or other point-to-point network, wireless or wired.

As shown, curiosity quotient computer network 100 further includes a content creator 108 also communicably coupled to curiosity quotient server 104 via Internet/communication network 106. An example of content creator 108 is a teacher or other expert or any entity that is skilled in a subject matter on which the content is based.

Content creator 108 (and 116) can create the subject matter content for consumption by users. An example of a user might be a knowledge acquirer or student. Once produced, the content is uploaded to curiosity quotient server 104 via computer device 110. Curiosity quotient server 104 can then be used to facilitate users' decision-making in selecting desired subject matter areas or categories in which to acquire knowledge. The amount of content available online is overwhelming. No amount of manual categorizing, comparison or sorting can effectively manage the amount of available content. Such voluminous amount of data significantly degrades the decision-making ability of users.

The present disclosure in one embodiment effectively manages data and facilitates a knowledge acquirer's decision to select subject matter categories or subsets thereof for viewing and acquiring knowledge about said subject matter. An embodiment assigns a CQ point value to subject matter based at least in part on the complexity of the subject matter or the length of the subject matter content viewed by a knowledge acquirer. A graphical interface conveys rotatable segmented wheel display to the knowledge acquirer that visually reflects the knowledge acquirer's interest level, experience, topics of interests and focus area sectors and CQ point value accumulation.

Curiosity quotient server 104 looks at what knowledge acquirers are into, their interest levels, their experiences and then develops a daily work out plan per subject matter category. A weighting generator is programmed to generate weights for the knowledge acquirer's interest level, experience, topics of interests and focus area. A higher weighting moves a circumferential arc beyond the circumference of the rotatable segmented wheel display while a lower weighting moves the circumferential arc below the circumference of the rotatable wheel.

Referring to FIG. 1, user 102 employs computing device 105 to access curiosity quotient server 104 to find and retrieve video content for subject matter upon which knowledge acquisition is to be based. Another user 112 might use computing device 114 to access curiosity quotient server 104.

Curiosity quotient server 104 uses its curiosity engine 123 to receive user input signals that indicate 1) levels of interest; 2) amount/level of user experience in a topic area; and 3) topic areas of interest to users. In turn, curiosity engine 123 generates and displays a personalized rotatable CQ wheel that can assist knowledge acquirers with visualizing the knowledge acquisition process each month as well as comparing knowledge acquirers' goals and interests. Curiosity engine 123 further builds a knowledge acquirer's CQ number, a measure of how much a knowledge acquirer learned in a period relative to how curious the knowledge acquirer is. The goal would be for knowledge acquirers to increase their CQ as they proceed with the knowledge acquisition process.

Referring now to FIG. 1, curiosity quotient server 104 includes lesson builder 118, video server 120, web server 122 and curiosity engine 123. Although shown separately as a server cluster, one skilled in the art will realize that the functionality of all of the servers can be provided by a single server. Here, web server 122 serves up web pages through which media content can be accessed by users 102 and 112. Such video content might be accessible, for example, at www.curious.com/learning-engine. Video server 120 retrieves available video content from database 124 for streaming or downloading to users 102 and 112. One skilled in the art will realize that video server 120 may include additional functionality.

The knowledge acquirer's demographic information may also be stored in knowledge acquirer database 125; subject matter assessment records may also be stored in database 127 and focus assessment information may be stored in database 129 as further described elsewhere in this disclosure.

Lesson builder 118 curates video content received from content owners and from original content created in-house for distribution to knowledge acquirers. After curation of content, lesson builder 118 might then generate one or more code instructions comprising embeddable video player 107 for downloading to client laptop 105. A brief summary of the operation of curiosity quotient computer network 100 will now be described.

In use, users such as user 102 and user 112 and other knowledge acquirers register and log onto curiosity quotient server 104. Knowledge acquirers would proceed through profiling, and subject assessment process that analyzes and assesses subject matter content of interest. A knowledge acquirer database provides records related to the knowledge acquirers. An assessment database records subject matter assessments for various predetermined subject matter categories.

A focus assessment database provides records related to the knowledge acquirer's focus area. A weighting generator generates weights for the knowledge acquirer's interest level, experience, topics of interests and focus area. A graphical interface conveys a rotatable wheel display to the knowledge acquirer. Weightings and the knowledge acquirer's interest level, experience, topics of interests and focus area are used to provide a list of subject matter content for viewing. In one embodiment, the present disclosure may be specially programmed using one or more of Ruby (leveraging the Ruby on Rails framework), Javascript, CSS, HTML.

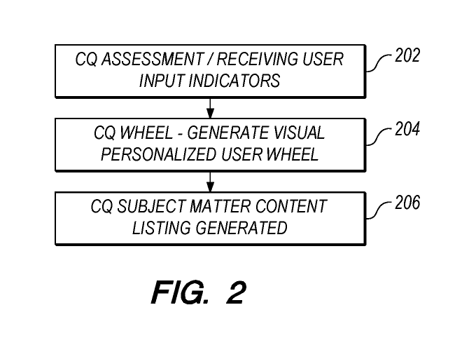

FIG. 2 illustrates three broad steps implemented by curiosity engine 123 of FIG. 1 according to an exemplary embodiment of the present disclosure.

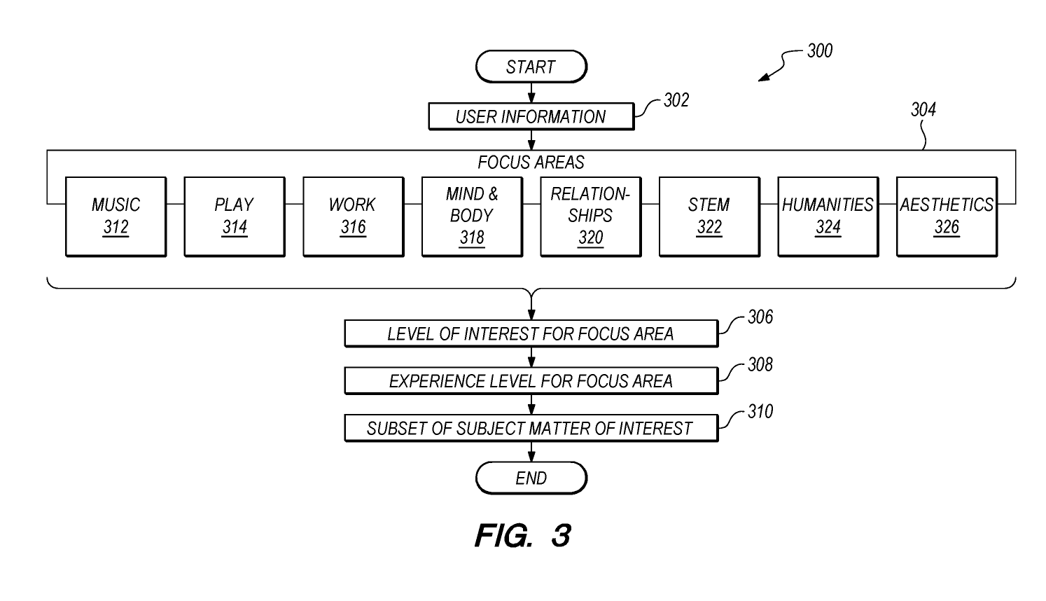

In FIG. 2, as a first step, at step 202, curiosity engine 123 (FIG. 1) implements an assessment stage. At this stage, curiosity engine 123 interfaces with a knowledge acquirer to receive user input indicators for several knowledge acquisition focus areas. A knowledge acquisition focus area, also referred to as subject matter, in one embodiment, is one of eight broad topics that capture the universe of knowledge acquisition as further discussed with reference to FIG. 3. The ability to classify the entire universe of knowledge into several distinct categories is itself challenging. The classification scheme is based on research conducted over two years and 5,000,000 knowledge acquisition sessions.

Here, specifically, curiosity engine 123 generates a user interface that receives, among other data, the level of interest the knowledge acquirer has in a knowledge acquisition focus area (also referred to as the knowledge acquirer's curiosity level), the knowledge acquirer's level of or amount of experience for a knowledge acquisition focus area and the subset of the knowledge acquisition focus area that the knowledge acquirer is interested in. In short, the assessment determines the knowledge acquirer's level of interest, experience for each category and allows the knowledge acquirer to highlight specific topics inside a knowledge acquisition focus area that the knowledge acquirer wishes to focus on.

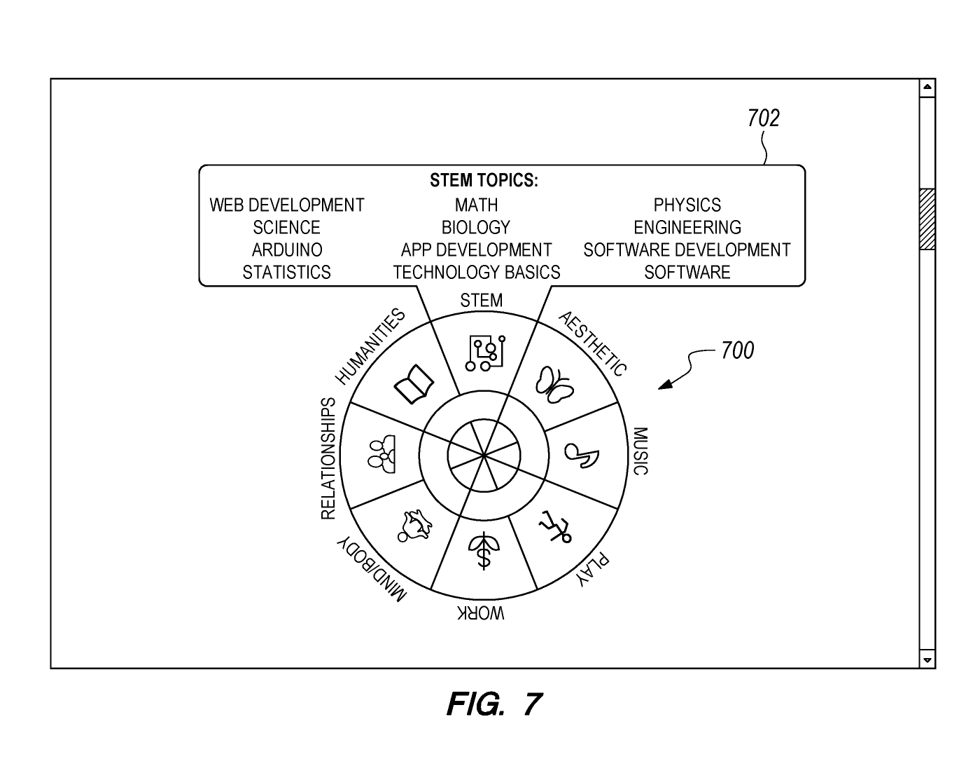

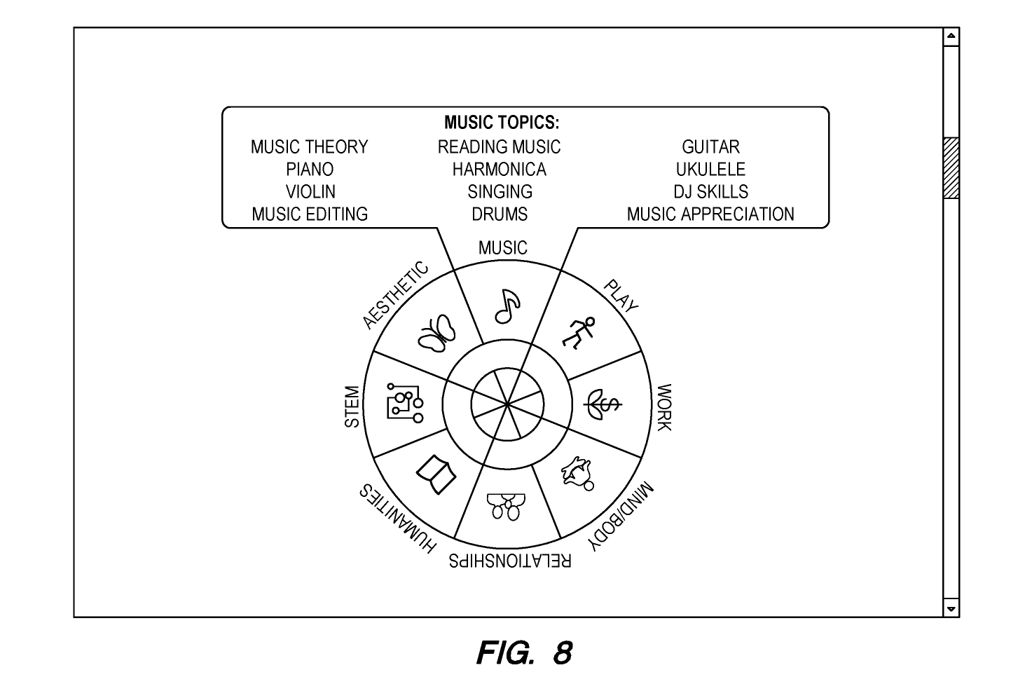

At a second step 204 of the interview stage, curiosity engine 123 generates and displays a CQ wheel shown in FIG. 7 for example. Based on the data from the user input indicators, curiosity engine 123 generates a CQ wheel for the knowledge acquirer. The rotatable CQ wheel shows the focus area and topics highlighted by the knowledge acquirer. The CQ wheel assists the knowledge acquirer in visualizing his or her knowledge acquisition progress through each month and compares knowledge acquisition progress to the knowledge acquirer's goals and interests. When first created, the wheel shows a knowledge acquirer's aspirations and sets up priorities and capacities in each area.

At a third step 206 of the interview stage, curiosity engine 123 generates subject matter categories of subsets of knowledge acquisition focus areas that the knowledge acquirer can acquire—that is topic areas that the knowledge acquirer can focus on and study on a daily basis. At this stage, curiosity engine 123 indicates the best way to build a knowledge acquirer's CQ and achieve monthly knowledge acquisition goals. The targeted list may be sent via daily email in one embodiment.

FIG. 3 illustrates a process 300 showing flow of the interview stage, wherein user input indicators that indicate interest and levels of interest and the focus areas of interest are received.

Broadly speaking, an advantage of the present disclosure is that the universe of knowledge acquisition is categorized into eight knowledge acquisition focus areas. The present inventors have determined that these eight knowledge acquisition focus areas are optimal. One skilled in the art will realize that the knowledge acquisition focus areas can be fewer or more than eight categories.

Among other reasons, the eight categories are optimal because the present disclosure employs a graphical interface for conveying a rotatable wheel display to knowledge acquirers. The rotatable wheel display is segmented into eight same-sized sectors. In order to use diameters to generate same-sized sectors, the rotatable wheel must be segmented into even sectors, that is, into two, four, six, eight, 10, etc, sectors. Two, four or six sectors are too little to encompass the entire universe of knowledge acquisition that are displayed on the wheel, while 10 or higher sectors create sectors that are too small to display any meaningful information.

By categorizing the universe of knowledge into the aforementioned categories, an embodiment of the present disclosure facilitates profiling of knowledge acquirers' experiences, interest levels and knowledge acquisition objectives in an instantly perceptible part-to-whole relationship. The rotatable wheel conveys this part-to-whole relationship easily. For example, it can be seen that each of the parts of the universe of knowledge (e.g. play, music, mind and body, etc.) that is represented by a sector is the same as another sector.

That is, play is ⅛^{th} of the universe of knowledge, music is ⅛^{th}, Aesthetic is ⅛^{th}, humanities ⅛^{th}, STEM ⅛^{th}, relationships ⅛^{th}, mind and body ⅛^{th} and work is ⅛^{th}. This visually conveys that since each of the knowledge sectors is the same, no area of the universe of knowledge is more important than the other. However, because each of the knowledge sectors is composed of different experiences, interests focus areas, etc., simply representing them by sectors of the rotatable wheel will not reflect such factors. While the rotatable wheel assists in comparing magnitude, unlike conventional systems, which increases the angles of sectors to represent quantities, embodiments of the present invention use weightings of the various factors to increase the sector arcs beyond the wheel circumference or reduce the sector arcs before the wheel circumference. Each sector is further segmented by secondary arcs. Further yet, in another embodiment, each subtopic of a knowledge area or sector is represented as a spoke along the circumference of the wheel.

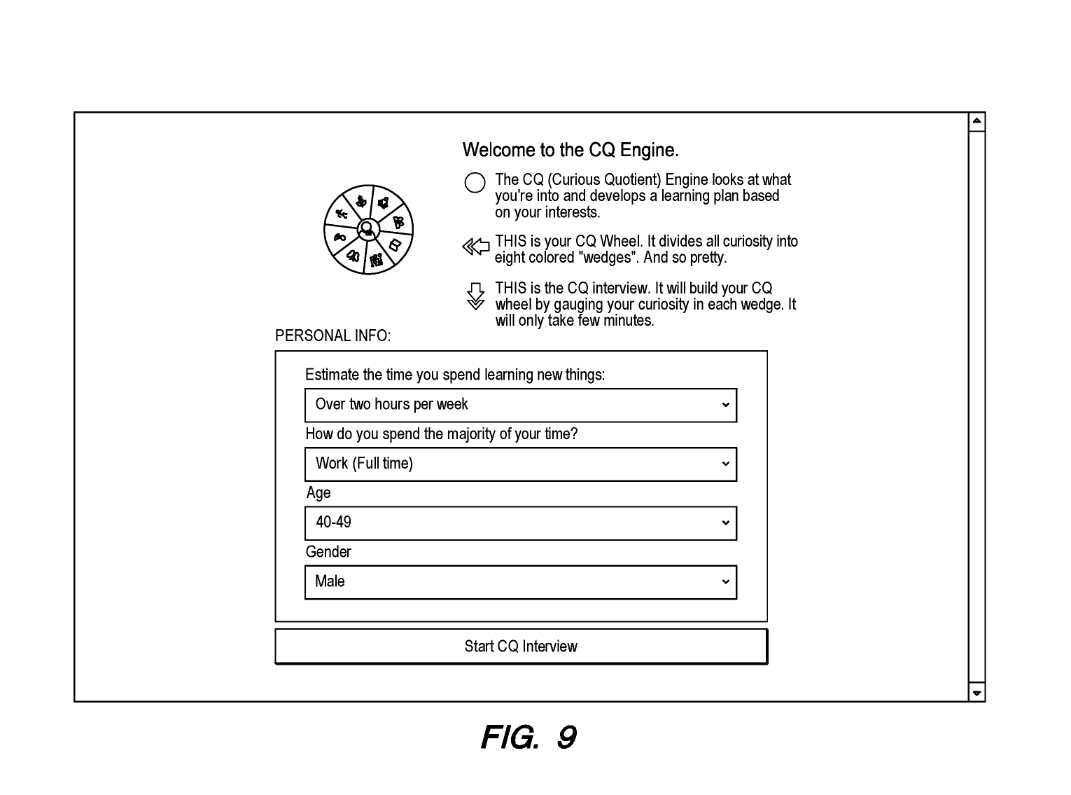

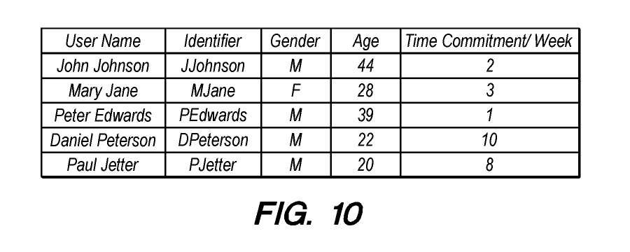

At Step 302, the interview stage process begins, curiosity engine 123 employs the user interface of FIG. 9 to collect demographic user information from the knowledge acquirer. Demographic user information might include the knowledge acquirer's name, gender, age and/or amount of time that the knowledge acquirer wishes to commit to knowledge acquisition each day, week, etc. As an example, the knowledge acquirer may designate 30 minutes/per day or one to two hours per week for new knowledge acquisition. Such demographic user information might be stored in knowledge acquirer database 125 (of FIG. 1).

At step 302 of FIG. 3, after knowledge acquirer information has been collected, curiosity engine 123 displays the first of eight knowledge acquisition focus areas for which user input indicators may be received. As shown, the first knowledge acquisition focus area is music 312. Other knowledge acquisition focus areas are play 314, work 316, mind & body 318, relationships 320, S.T.E.M. 322, humanities 324 and aesthetics 326. Information for each of the knowledge acquisition focus areas is collected.

As noted, the first focus area for which information is received is music 312. Music is defined as pertaining to vocal or instrument sounds or reading of printed signs representing vocal or instrument sounds. It includes a universe of musical instruments and knowledge acquisition, singing, conducting, appreciation of music or the like.

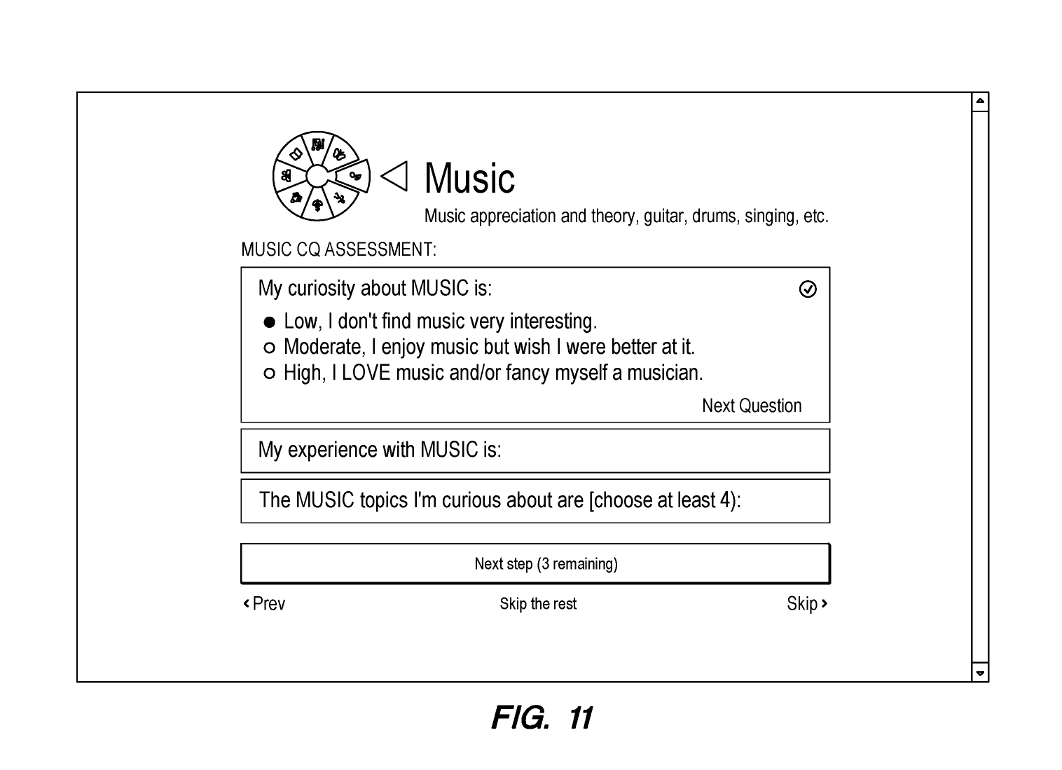

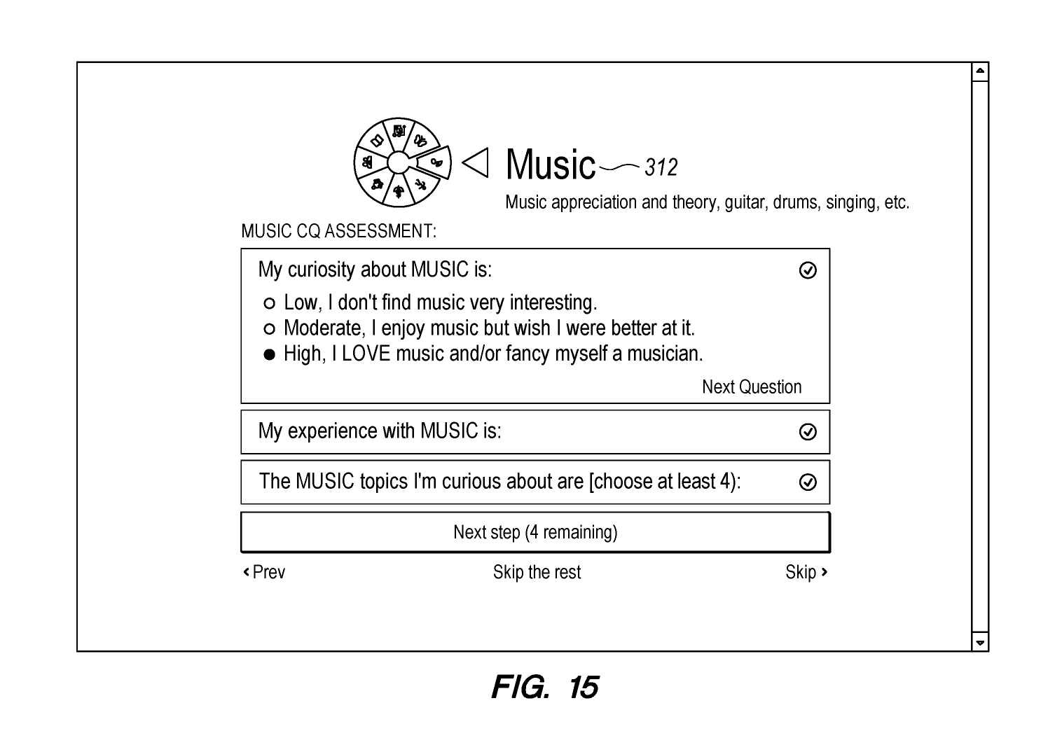

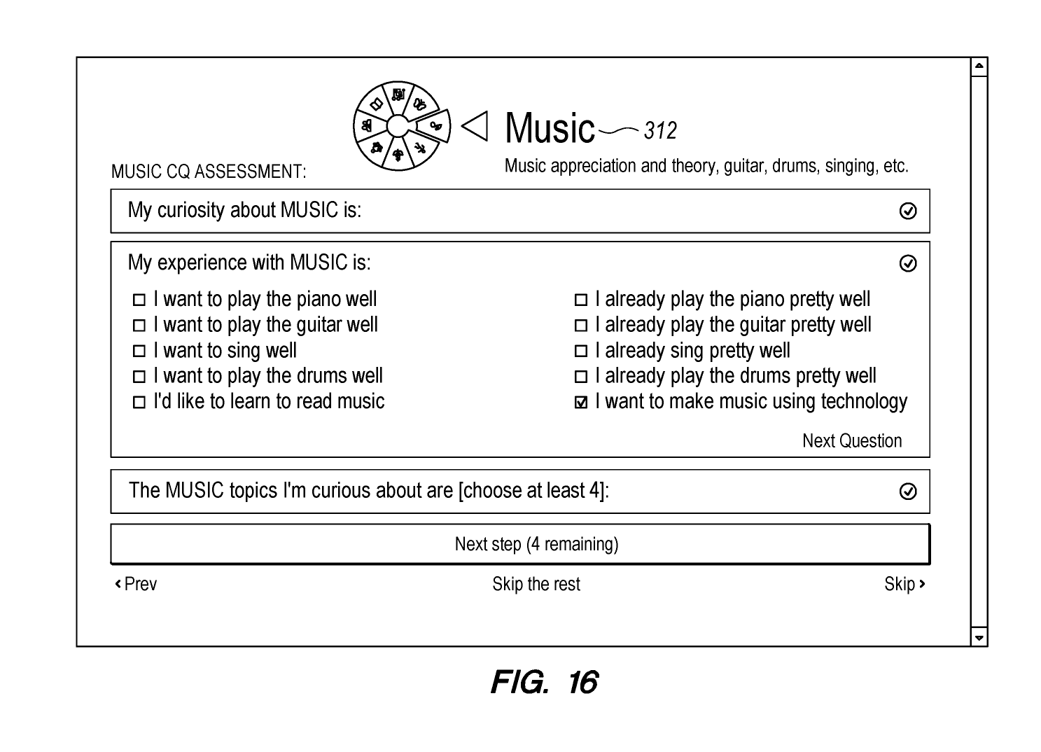

User interface screens for collecting music information are shown in FIGS. 11-17.

In FIG. 3, at step 306, and FIG. 1, curiosity engine 123 begins by assessing the curiosity level or the level of interest of the knowledge acquirer. Here, the knowledge acquirer is requested to indicate the level of interest that the knowledge acquirer has in music. Curiosity engine 123 designates three levels of interest, namely, low, moderate and high. Here, the knowledge acquirer has selected “Low, I don't find music very interesting.” The knowledge acquirer may also select “Moderate. I enjoy music but wish I were better at it” or “High. I love music and fancy myself a musician.”

The inventors of the present disclosure have determined that applying a three-scale level of interest is optimum for the present embodiment. However, a two-scale level of interest may also be applied. That is, the level of interest that the knowledge acquirer indicates may simply be either low or high or 1 or 2 for example.

Another advantage of the present disclosure is that unlike conventional systems, curiosity engine 123 obtains its information directly from the knowledge acquirer by simply requesting permissive assessment information from the knowledge acquirer. Curiosity engine 123 does not guess or try to determine the knowledge acquirer's level of interest based on the knowledge acquirer's purchases or previous actions.

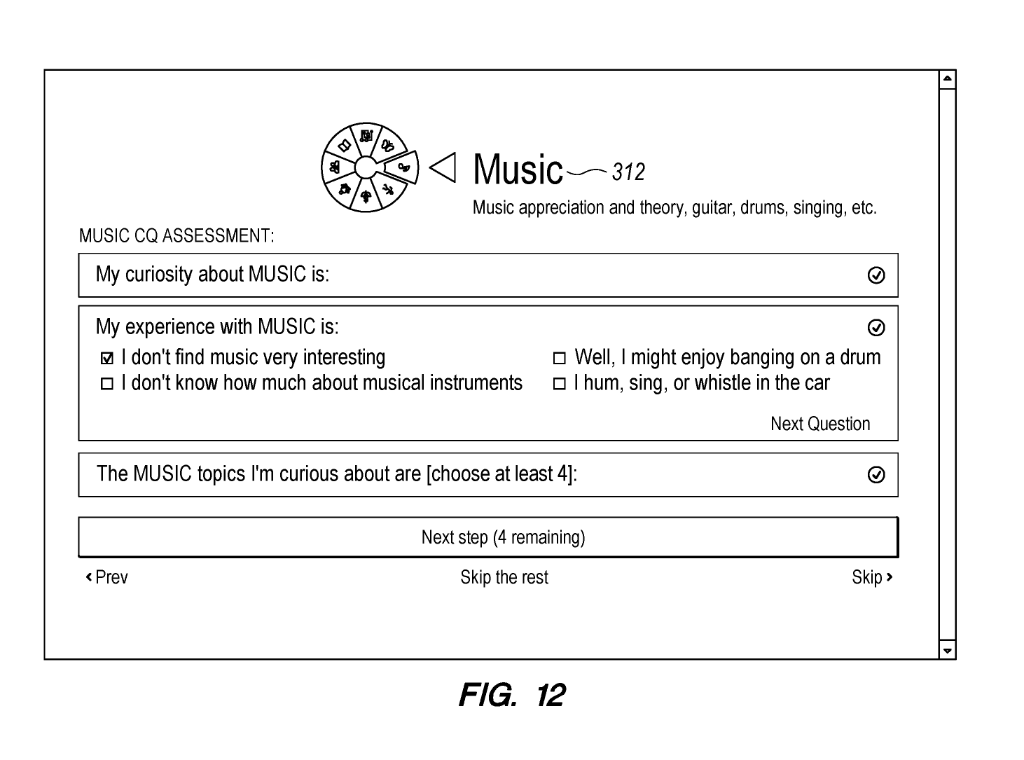

In FIG. 3, at step 308, after the knowledge acquirer indicates the knowledge acquirer's level of interest in music, as shown in FIG. 12, the knowledge acquirer can then indicate the knowledge acquirer's experience in music. Among the available options, he or she may select “I don't find music very interesting,” “ I don't know much about musical instruments,” “Well, I might enjoy banging on a drum,” or “I hum, sing, or whistle in the car.”

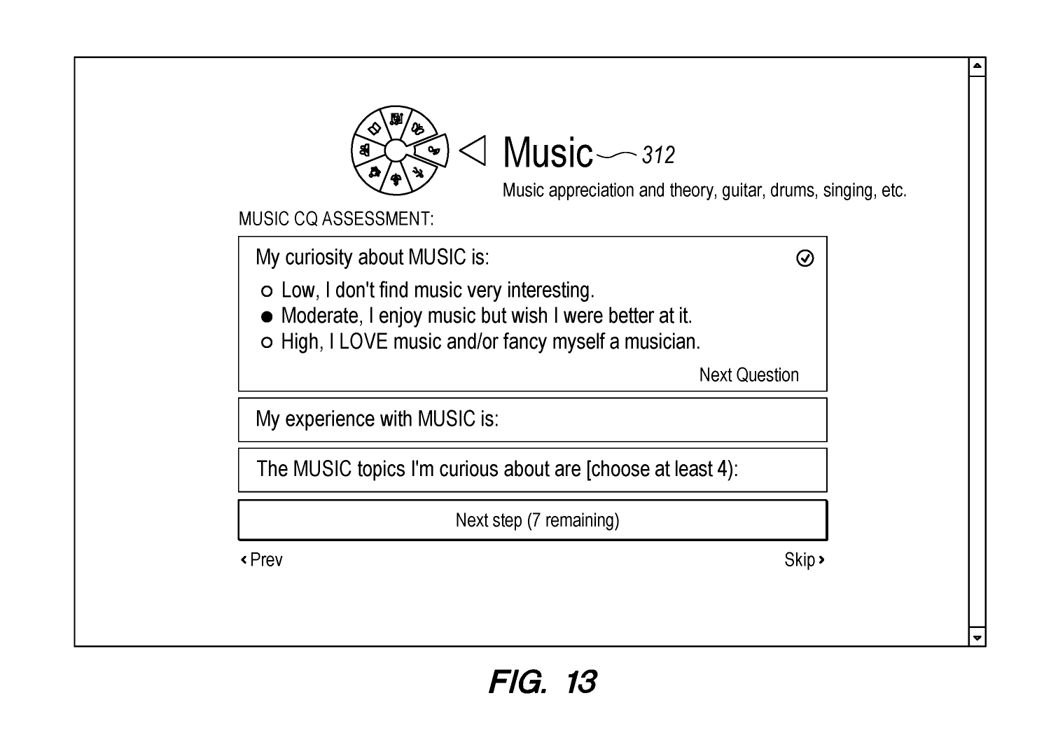

The number of options presented to the knowledge acquirer is dependent or based upon the level of interest expressed by the knowledge acquirer in FIG. 11. If the knowledge acquirer's level of interest in music is low, the number of options for knowledge acquirer experience is limited. If the knowledge acquirer's level of interest is moderate, as shown in FIG. 13, the available options for knowledge acquirer experience are increased.

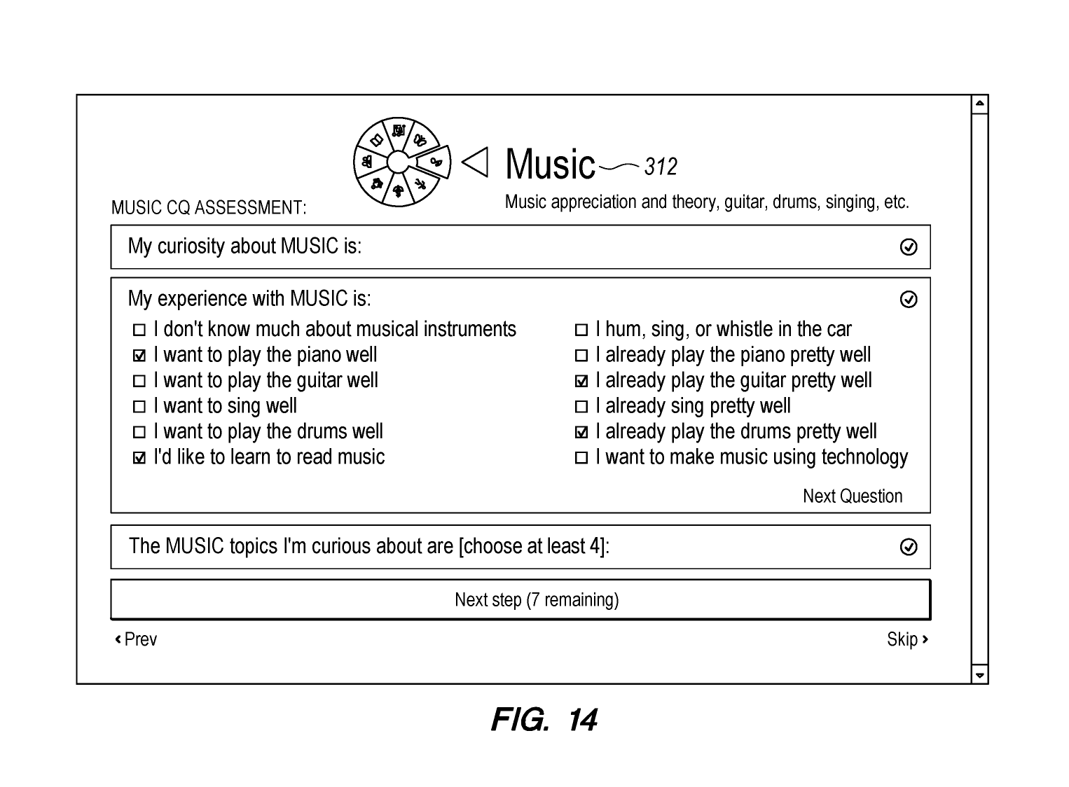

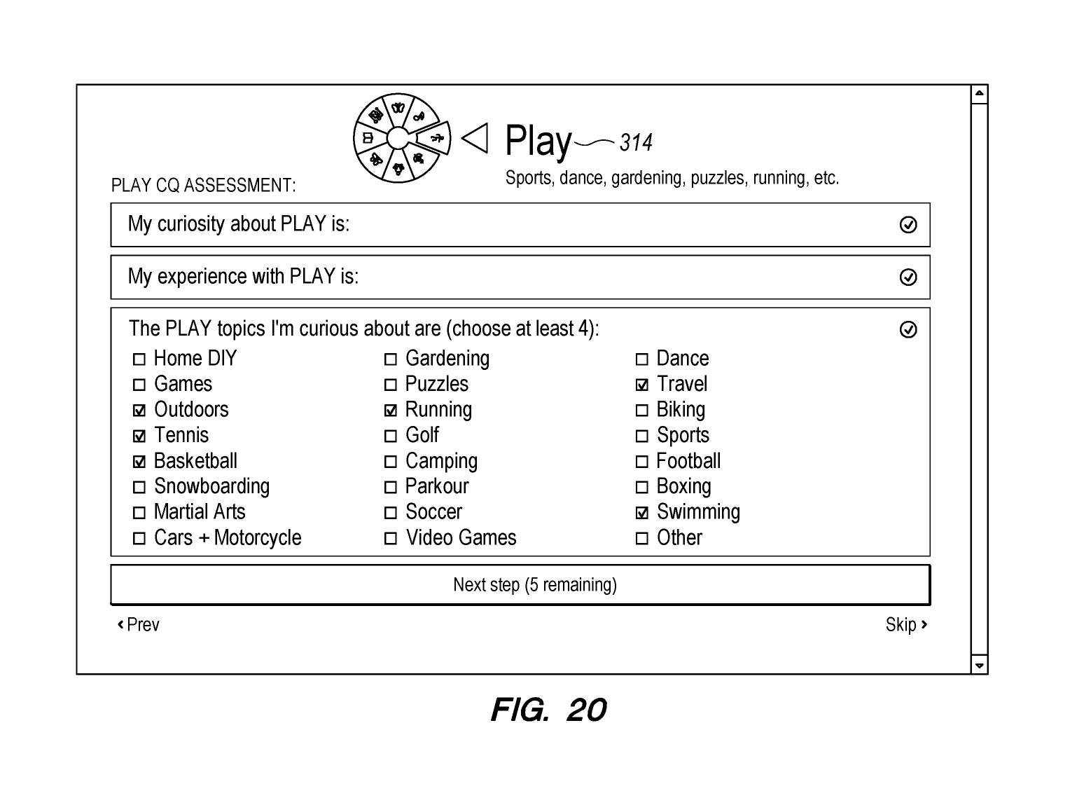

In FIG. 14, for example, the knowledge acquirer's experience level can be “I don't know much about musical instruments,” “I want to play the piano well,” “I want to play the guitar well,” “I want to sing well,” “ I want to play the drums well,” “I′d like to learn to read music,” “I hum, sing, or whistle in the car,” and so forth as shown in FIG. 20. Therefore, the present disclosure is intuitive in that if the knowledge acquirer's level of interest is low, then the knowledge acquirer's level of experience is likely low so that many user experience options are not needed.

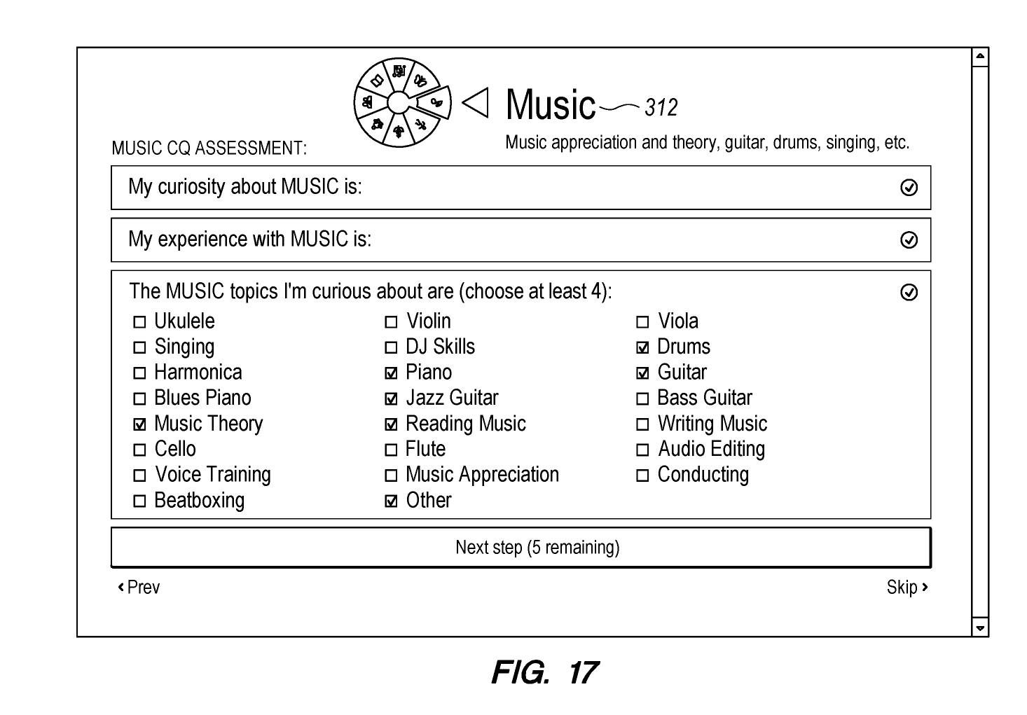

Referring to FIG. 3, at step 310, after a knowledge acquirer selects his or her level of experience in music, the knowledge acquirer can then select the music topics that the knowledge acquirer is curious about (or interested in). As shown in FIG. 17, the music topics that the knowledge acquirer is curious about can include ukulele, violin, viola, drum, guitar, audio editing channel, beat boxing, DJ skills, harmonica, singing, etc. and a catch-all checkbox “other.”

Although not shown, other areas or subsets of a music topic can be indicated at this stage for selection by the knowledge acquirer. In fact, the knowledge acquirer may simply indicate a desired music field of interest for processing by curiosity engine 123.

In FIG. 3, the process is repeated for every focus area; for each of play 314, work 316, mind & body 318, relationships 320, S.T.E.M. 322, humanities 324 and Aesthetics 326.

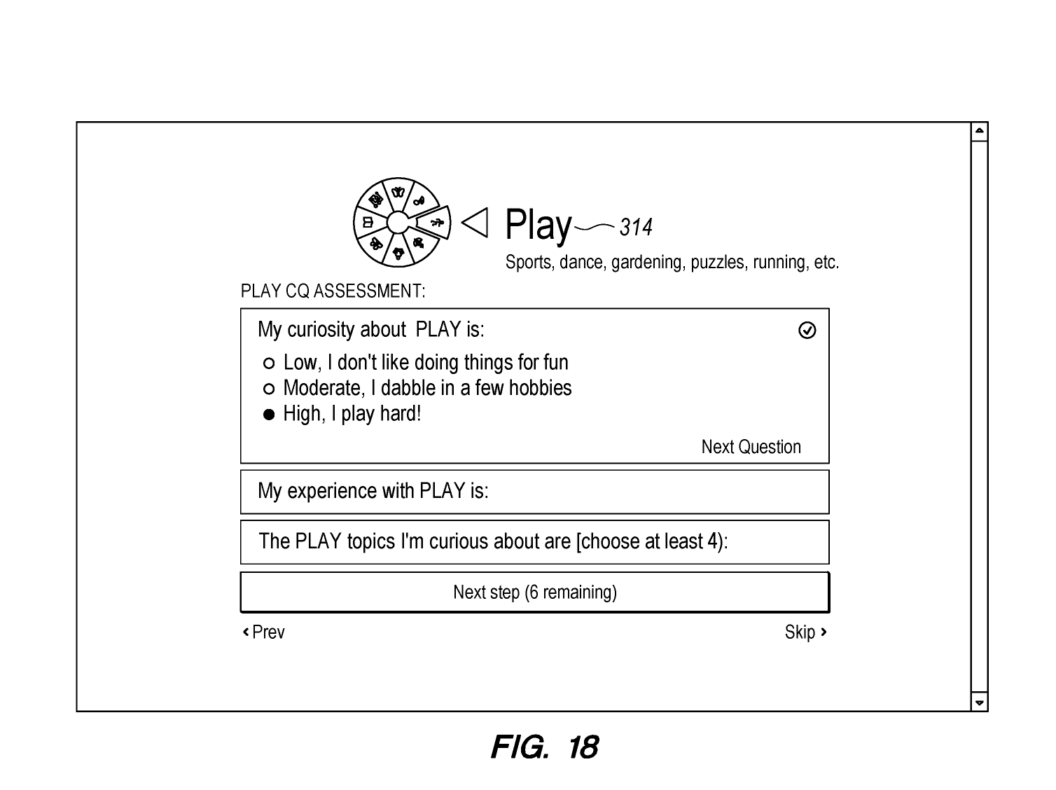

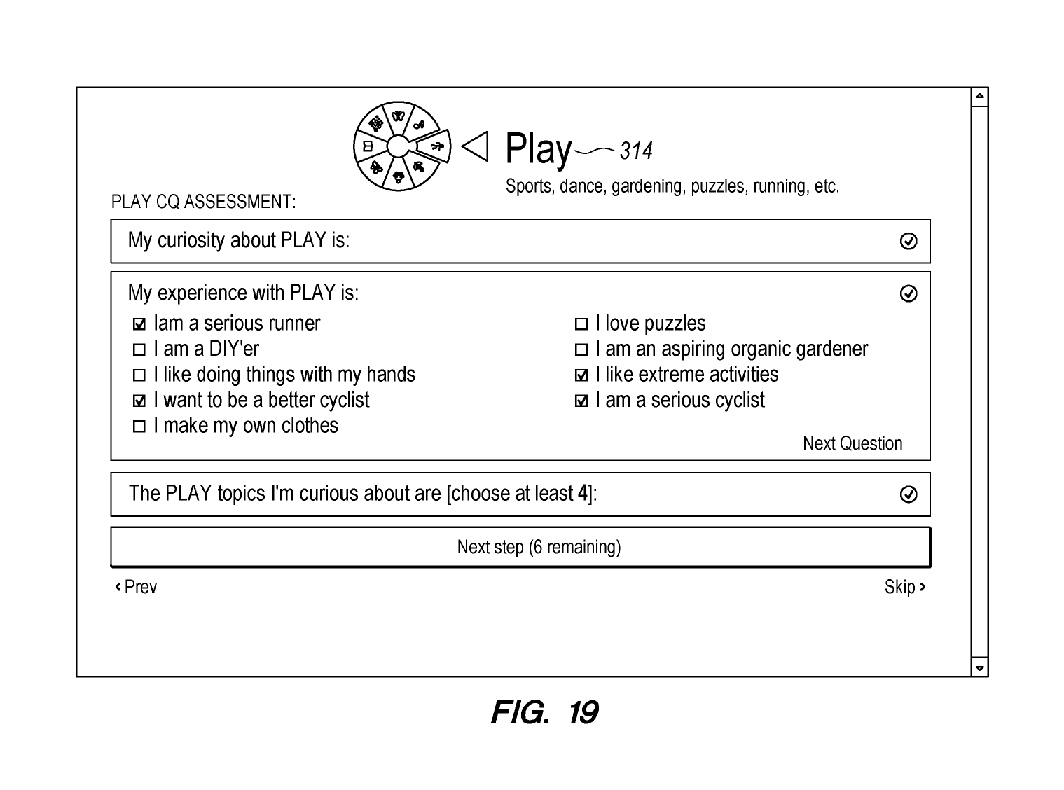

Specifically, after information for music 312 is gathered, information for play 314 is collected. The screenshots for play 314 are illustrated with reference to FIG. 18 through 20 for when curiosity about play is high. The screenshots for when curiosity about play is low and is moderate have been omitted for brevity sake. However, when curiosity about play is low, the knowledge acquirer's experience options include “I like to save money by doing things myself,” “I enjoy being outdoors,” “Okay, I sometimes play games,” and “I love puzzles.”

When the knowledge acquirer's curiosity is moderate, the experience options include “I′d like to be a better runner,” “I love puzzles,” “I like doing things with my hands,” “I want to be a better cyclist,” “I′d like to get into playing a sport,” “I am a DIY′er,” “I like extreme activities.” Play is defined as activities that are engaged in for enjoyment and recreation rather than for a serious or practical purpose. An advantage of the present disclosure is that as noted, the universe of knowledge acquisition has been condensed into several defined specific areas, with play being one of such knowledge acquisition focus areas. Within play itself, there are several subsets or segments such as sports, cooking, games, clothes making, running, baking, do-it-yourself, yam arts, biking, dance, crafting, gardening and the like. Other activities for enjoyment can also be included within the play topics.

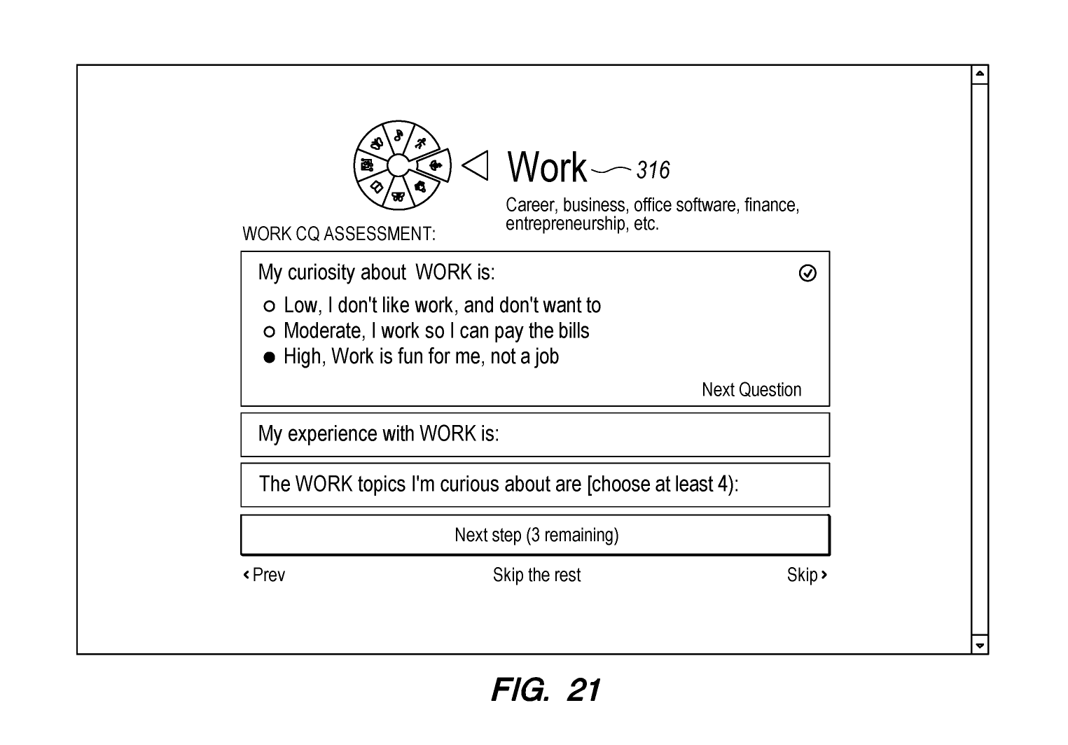

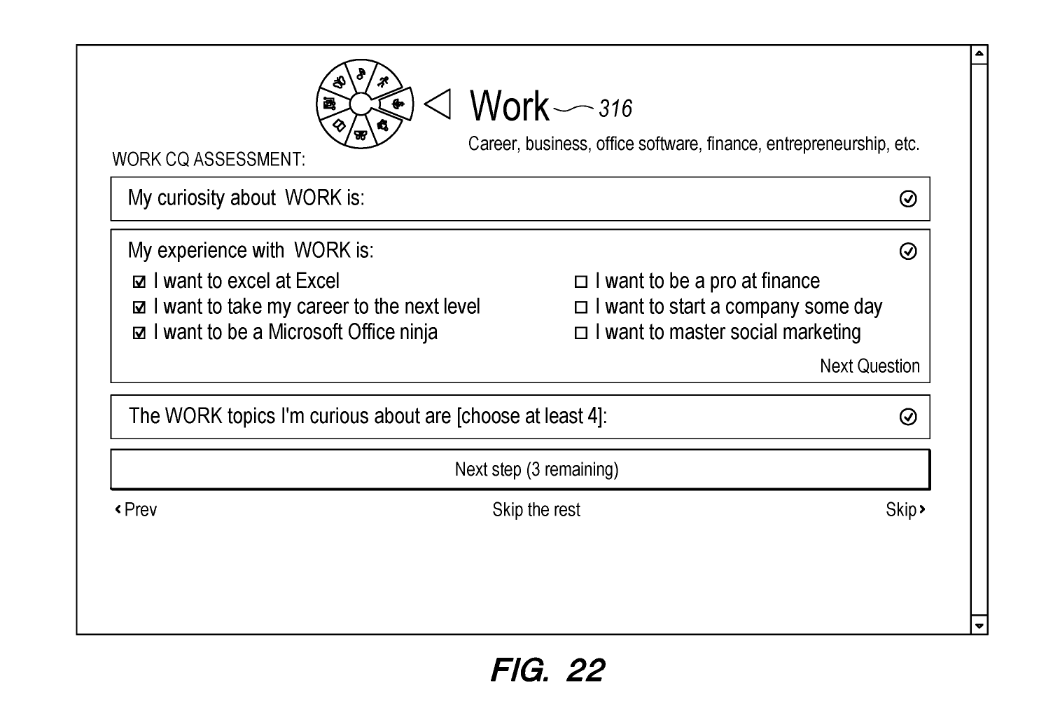

After the user input indicators for play are received, curiosity engine 123 requests information for work 316. Work 316 screenshots are illustrated with reference to FIG. 21 through FIG. 23 for when the knowledge acquirer's curiosity about work is high. The screenshots for when curiosity about work is low and when curiosity is moderate have been omitted for brevity sake.

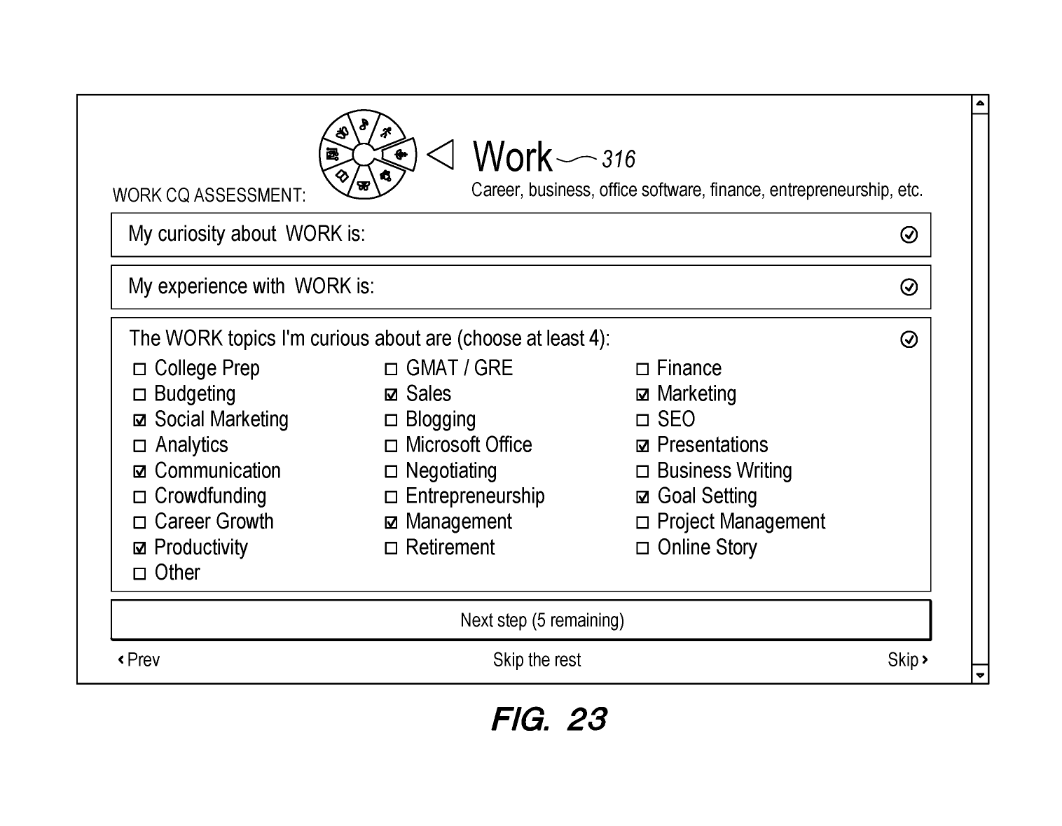

Work includes any mental or physical activity that's geared towards employment or may be any such mental or physical effort engaged in to achieve a purpose or result. As can be seen in FIG. 23, work topics that have been selected by the knowledge acquirer include social market, communication, productivity, sales, management, marketing, presentations and goal setting. One skilled in the art will realize that fewer or more topics may be included under the work category.

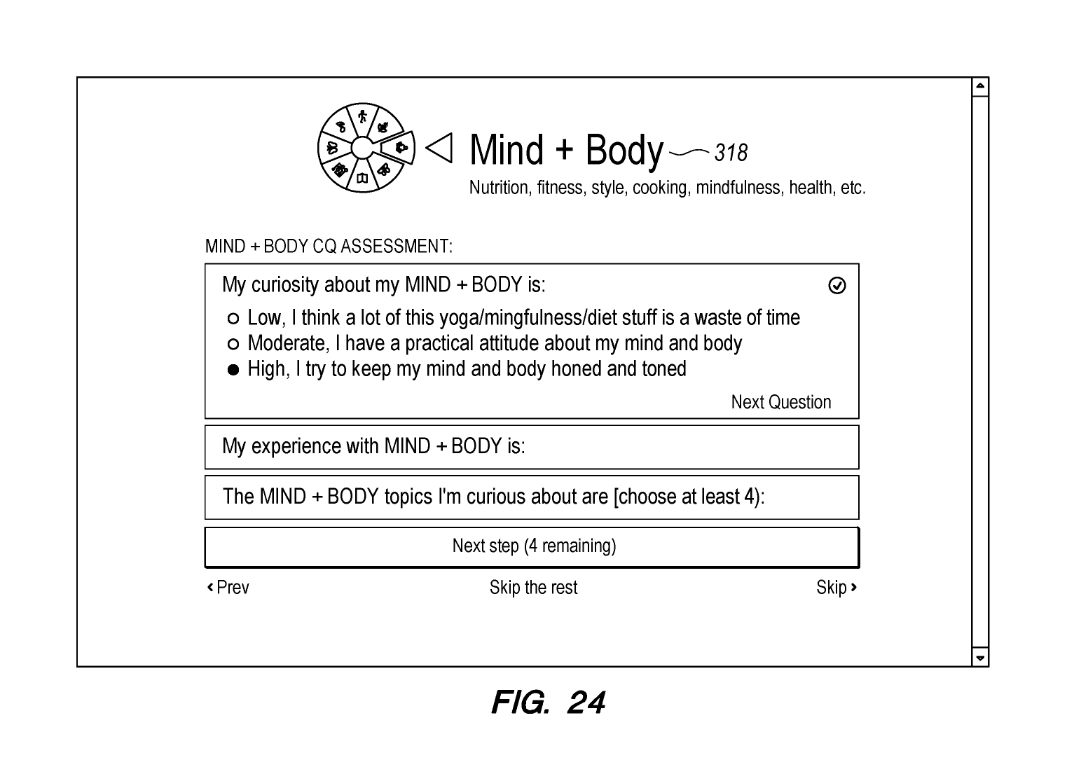

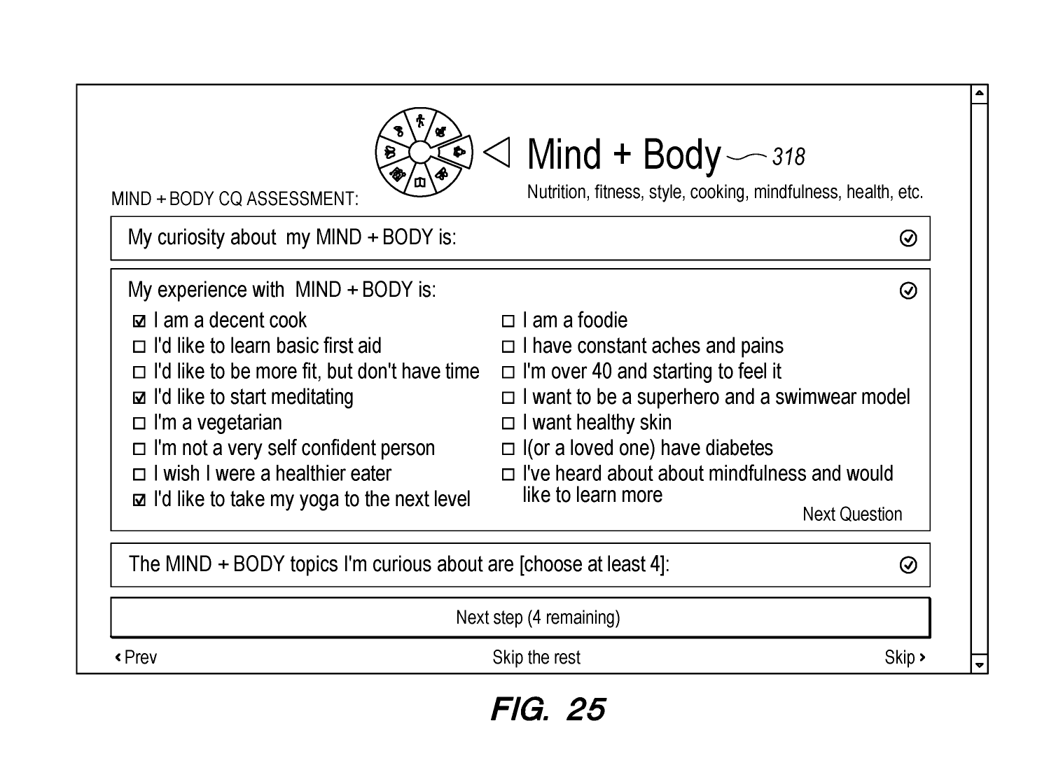

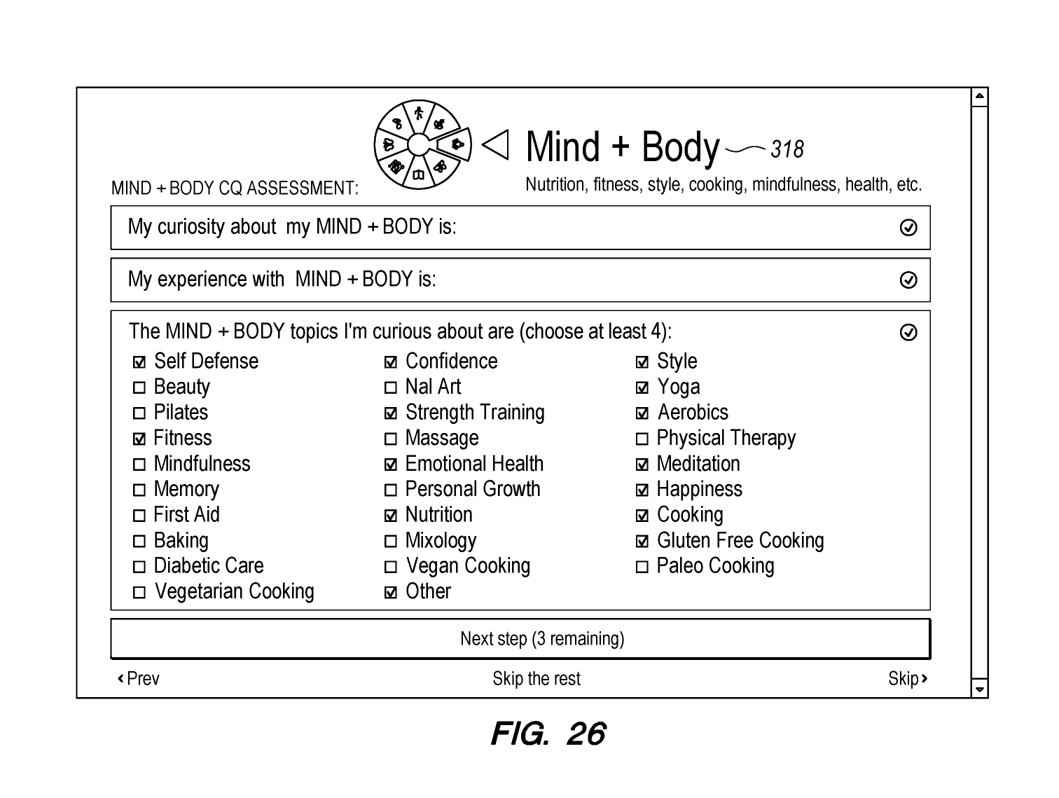

After work information is collected, curiosity engine 123 collects information on mind & body 318. Mind & body screenshots are illustrated with reference to FIG. 24-26 for when the knowledge acquirer's curiosity about mind and body is high. The screenshots for low and moderate curiosity have been omitted. Mind & body topics include but are not limited to food and nutrition, style and beauty, spirituality, emotional health, personal growth, mental well-being, yoga and Pilates, self-defense, meditation, fitness, physical therapy and life skills as examples. These topics include any activity or effort that promotes emotional, physical and psychological well-being of the knowledge acquirer.

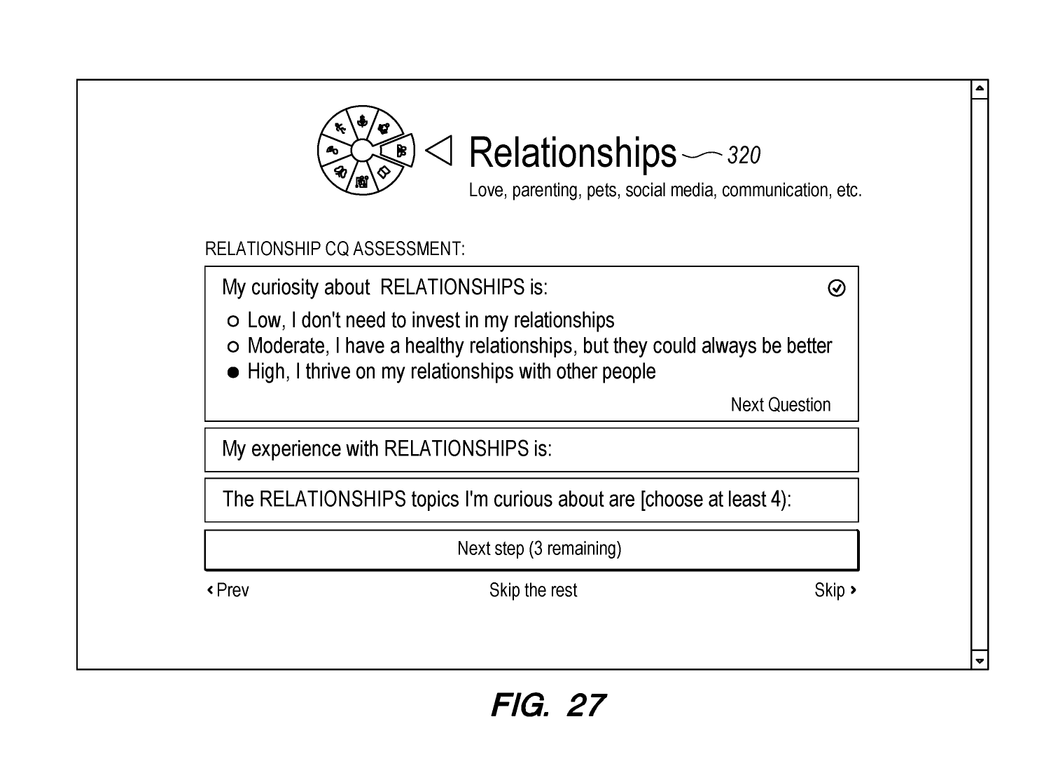

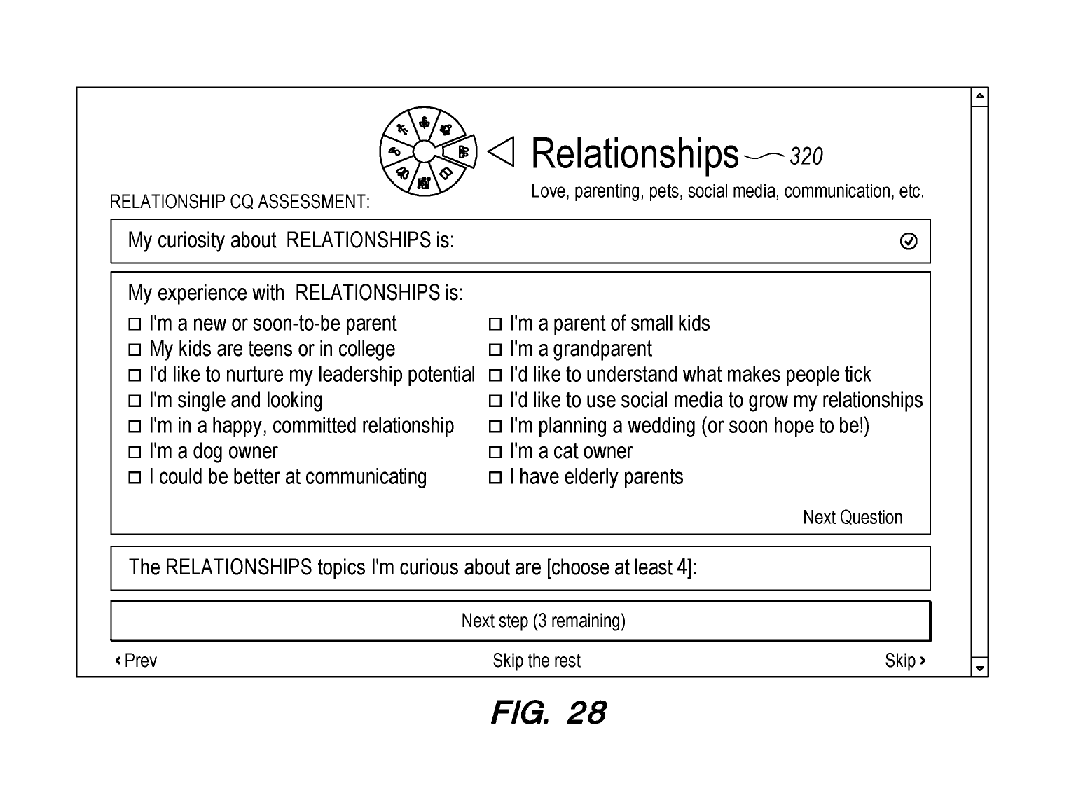

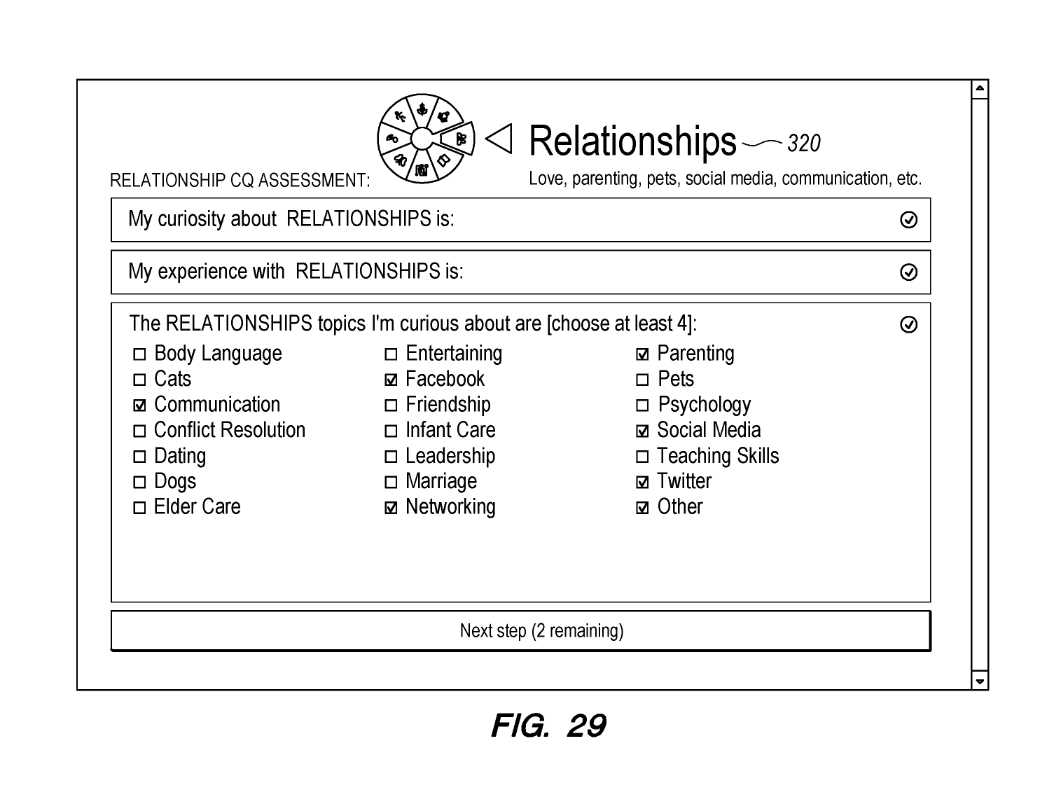

After mind & body information is collected, curiosity engine 123 presents a screenshot for relationships 320. Relationships screenshots are illustrated with regard to FIG. 27 through FIG. 29 for when a knowledge acquirer's curiosity about relationships is high. A relationship is the way in which two or more concepts, objects or people are connected or the state of being connected. Relationship topics include parenting, social media, psychology, teaching skills, communication, dating plus marriage, public speaking, entertaining, leadership, networking, first aid, pets and so forth. One of skill in the art will realize that any subset of topics may also be included in a different topic. For example, teaching skills may be included as a subset of work.

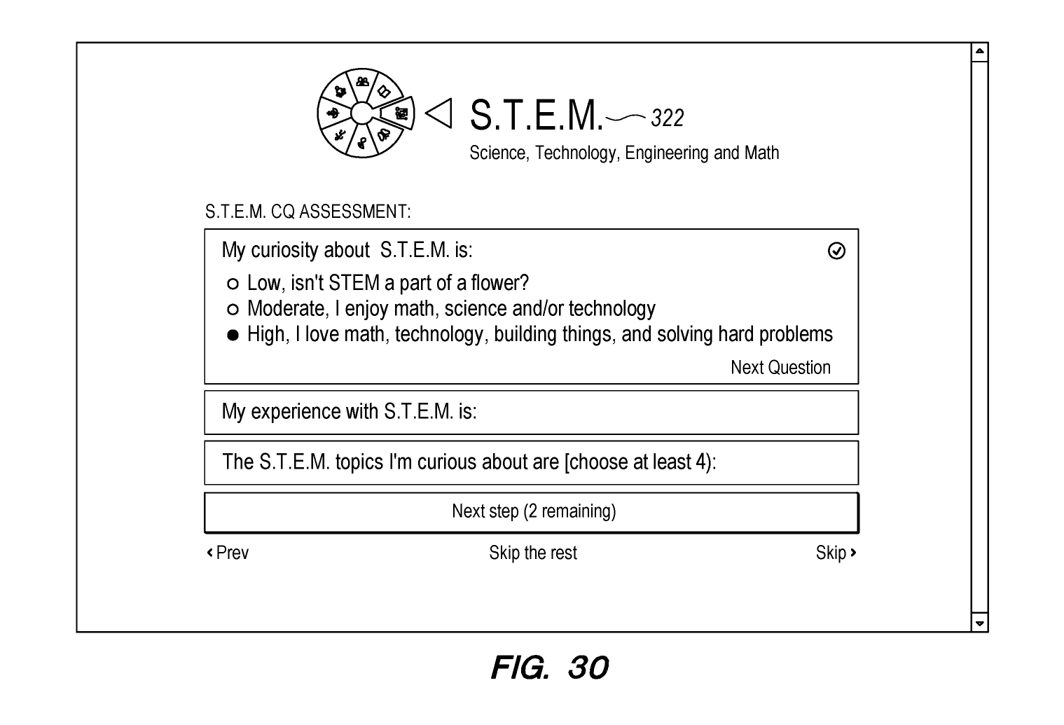

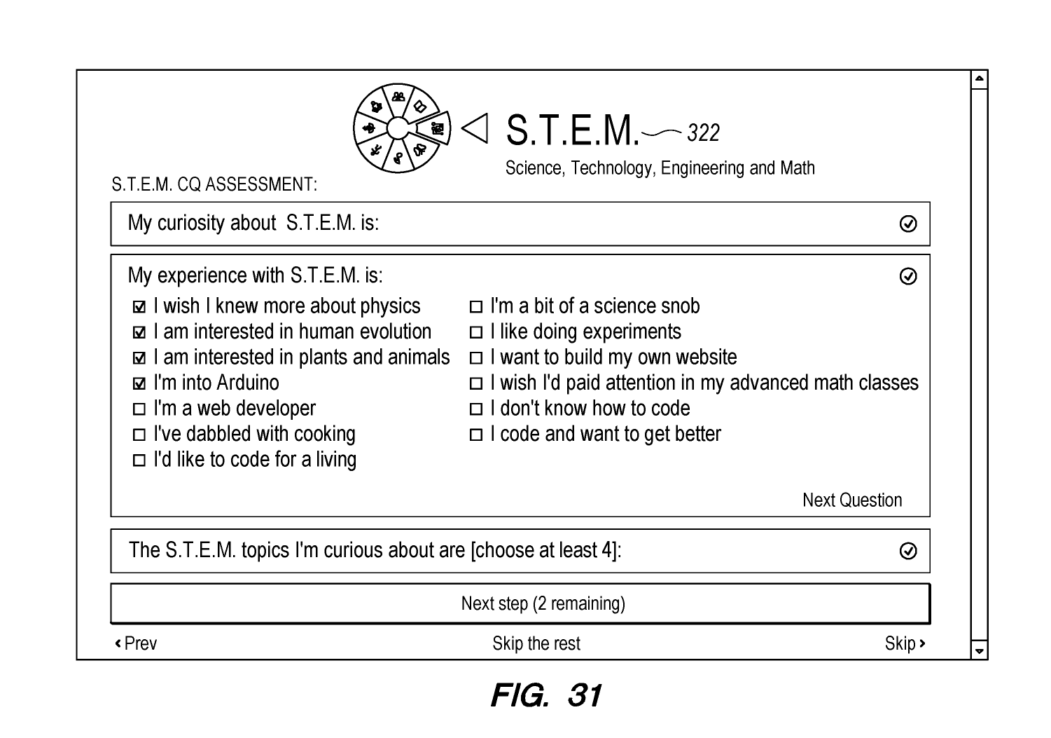

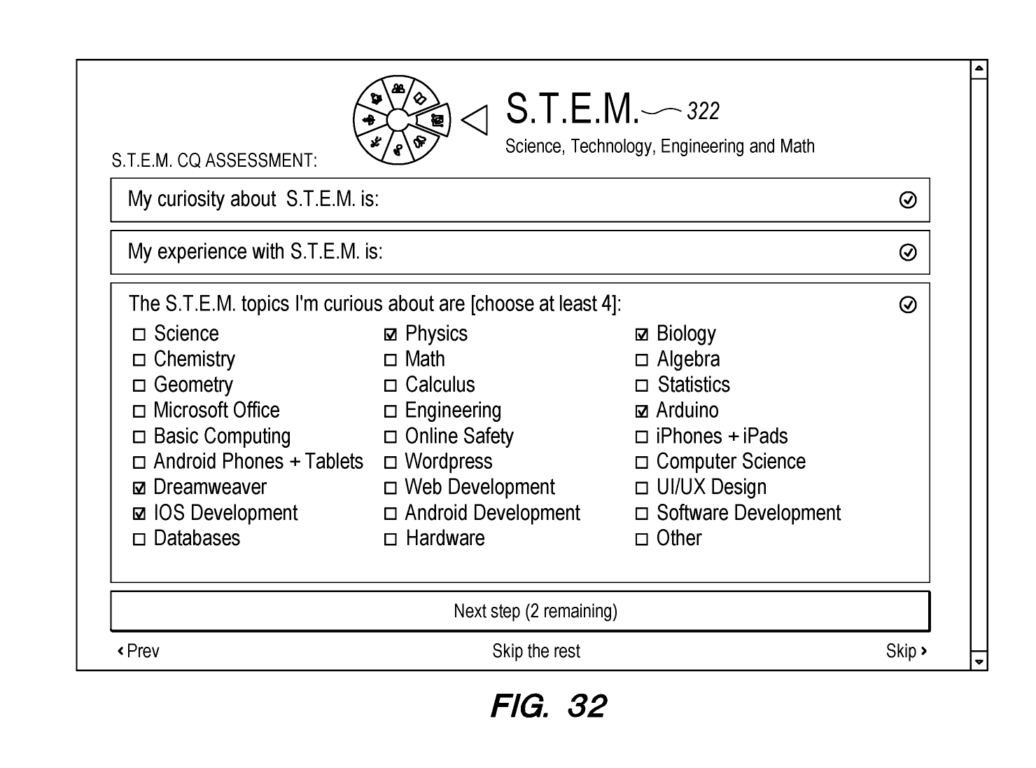

After this determination, curiosity engine 123 displays S.T.E.M. 322 to collect information from the knowledge acquirer. S.T.E.M. is an acronym for Science, Technology, Engineering and Math. Screenshots for S.T.E.M. 322 are shown in FIGS. 30-32 for the case where the knowledge acquirer's curiosity about S.T.E.M. is high. Conveniently, the present disclosure has combined science, technology, engineering and math as a topic under which subtopics such as Web development, science, Arduino, statistics, math, biology, app development, technology basics, physics, engineering, software development and software, for example, have been included.

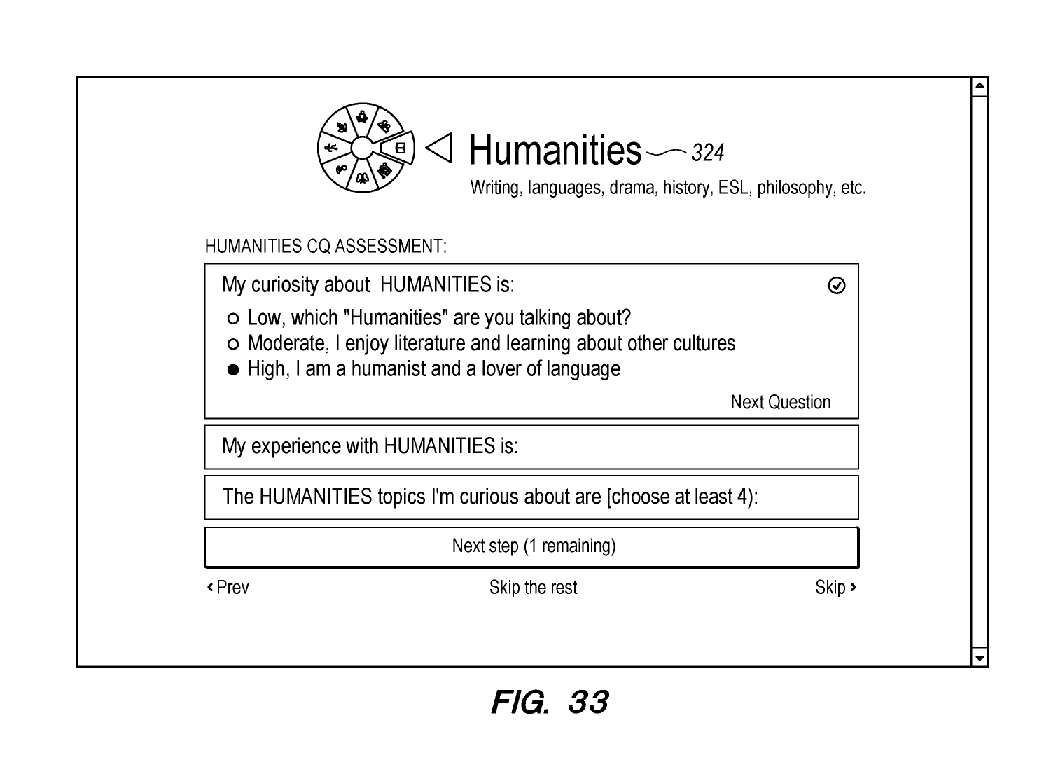

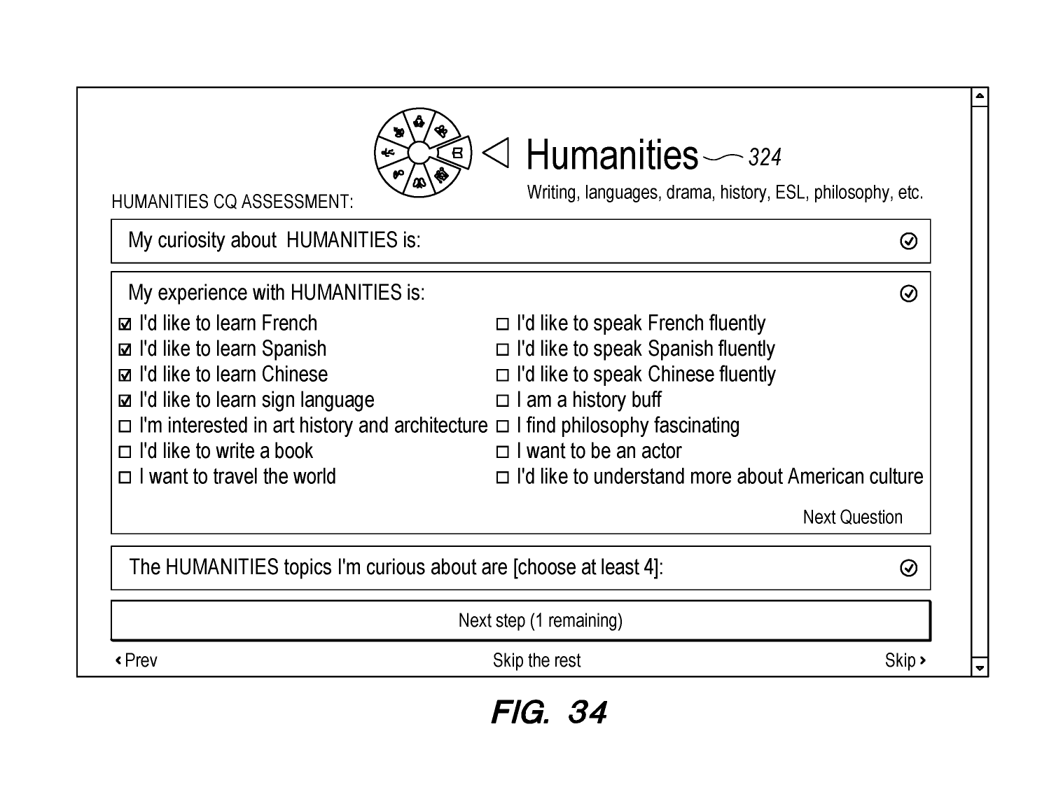

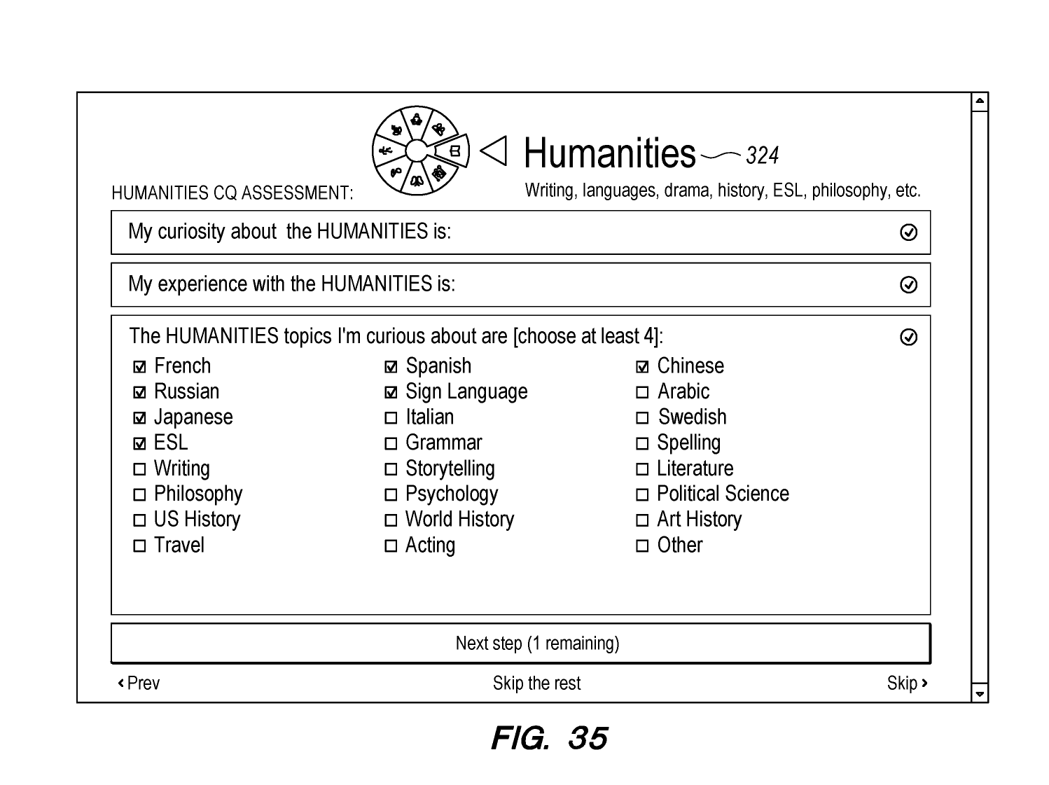

After information on S.T.E.M. information is received, curiosity engine 123 displays and requests information for humanities 324. Humanities 324 screenshots are illustrated with reference to FIG. 33 through FIG. 35 for when the knowledge acquirer's curiosity about humanities is high. Humanities can be described as how people process and document the human experience. Humanities topics include history, philosophy, French, Russian, writing, psychology, Spanish, sign language, political science, foreign languages, Chinese, spelling and grammar as examples. At step 306, 308 and 310, the knowledge acquirer's level of interest for humanities and the knowledge acquirer's experience for the focus area are determined after which the S.T.E.M. focus area is displayed.

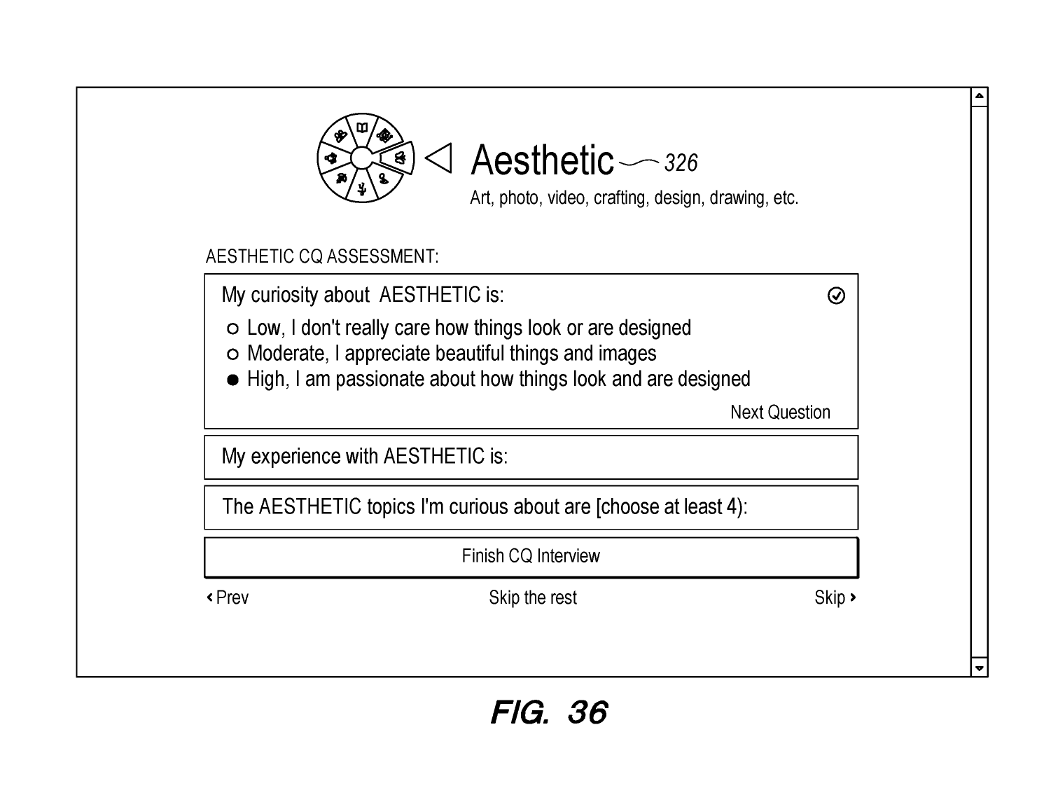

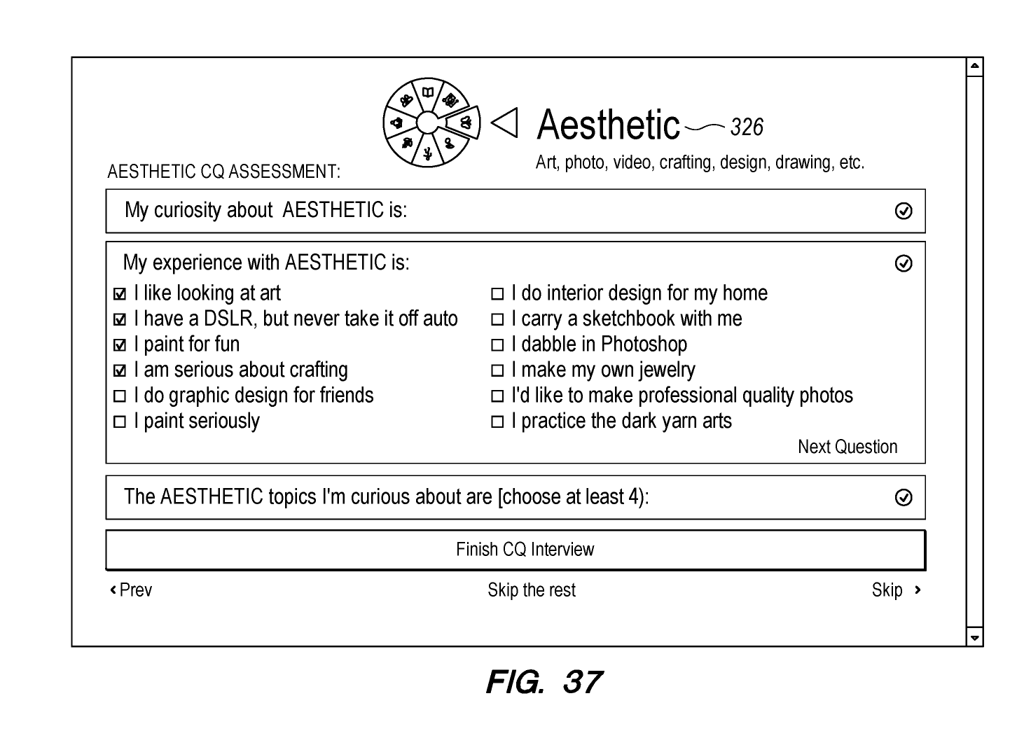

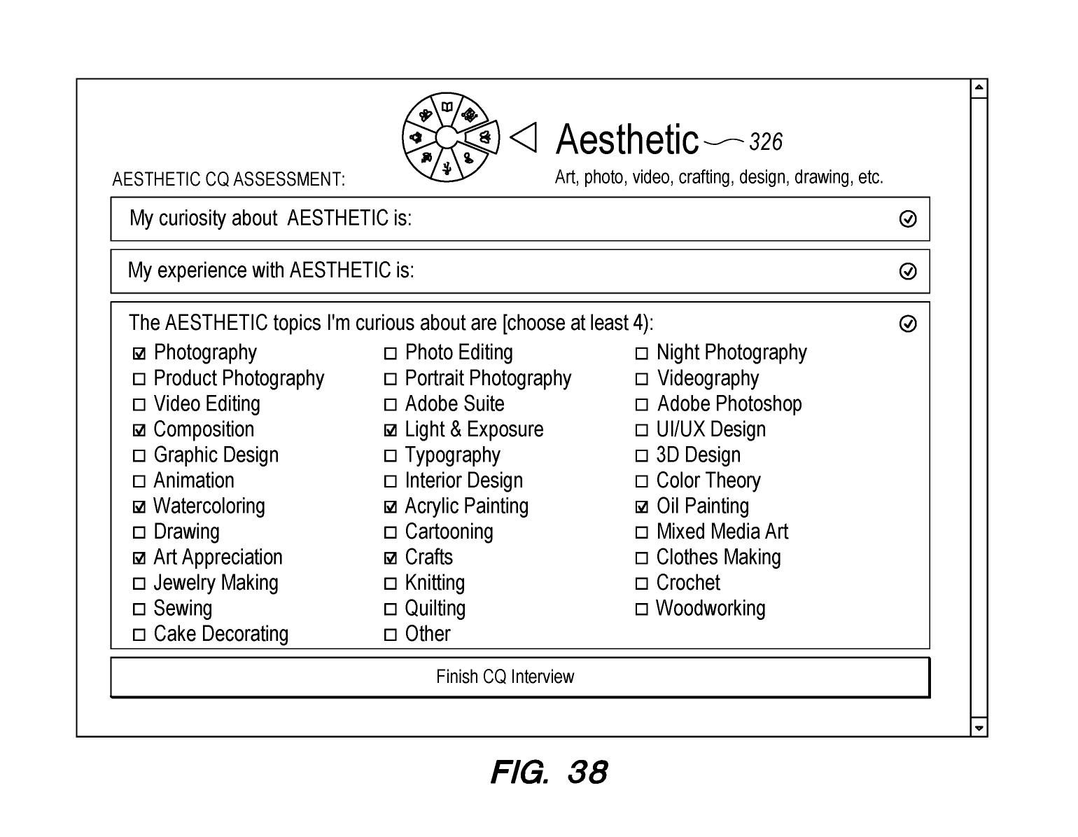

After humanities information is collected, curiosity engine 123 collects information for aesthetics 326. Aesthetics 326 screenshots are illustrated with respect to FIGS. 36 through 38 when the knowledge acquirer indicates a high curiosity level for Aesthetics. Aesthetics is defined as the nature and appreciation of beauty especially in the arts or as it relates to the principles of beauty and artistic taste. Aesthetics 326 includes painting, 3-D design, photo editing, art appreciation, drawing, photography, graphic design, UI design, animating, film-making, Adobe Creative Suite and interior design for example.

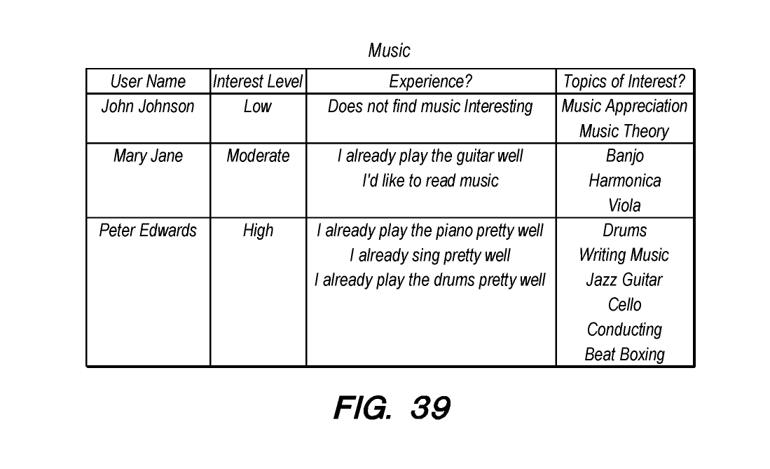

After collection, all of the subject matter assessment information is stored by curiosity engine 123 in database 127. Records contained in a database table are specifically stored in the database. Each stored record may be reflected as in FIG. 39, which shows a knowledge acquirers' subject matter assessment for music. Based on the knowledge acquirer's responses, knowledge acquirer John Johnson's interest level in music is low; he does not find music interesting and he is interested in music appreciation and music theory.

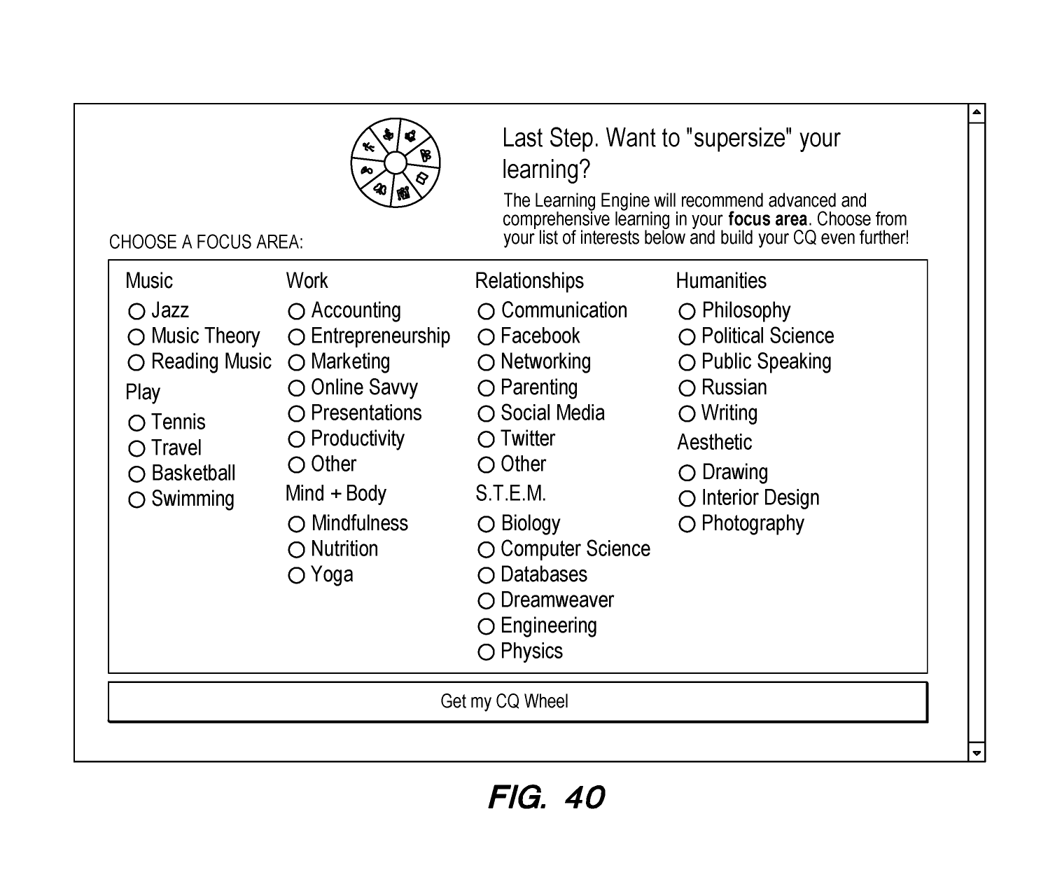

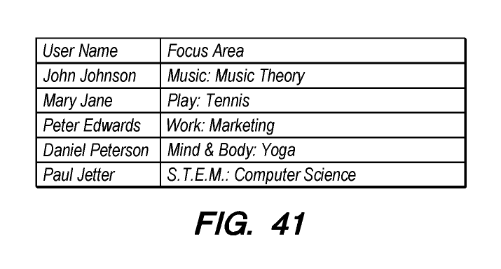

Curiosity engine 123 further provides focus assessment by providing the knowledge acquirer with an opportunity to select a focus area, which is a subset or subtopic selected from the subject matter categories. By selecting a focus area, additional advanced materials in the focus area, which may be weighted with prior specified parameters can be provided the knowledge acquirer. FIG. 40 shows a focus assessment screenshot from which a single subtopic is selectable. FIG. 41 is a table with focus assessment records for a number of knowledge acquirers.

Thereafter, a weighting generator or specialized program that generates weights for the knowledge acquirer's interest level, experience, topics of interests and focus area. In one aspect, the weighting generator generates weights based at least in part on relative importance assigned to each factor. In one embodiment, the weights may be based at least in part on whether a focus area is selected, previously viewed subject matter, highly rated content, complexity, experience level, for example.

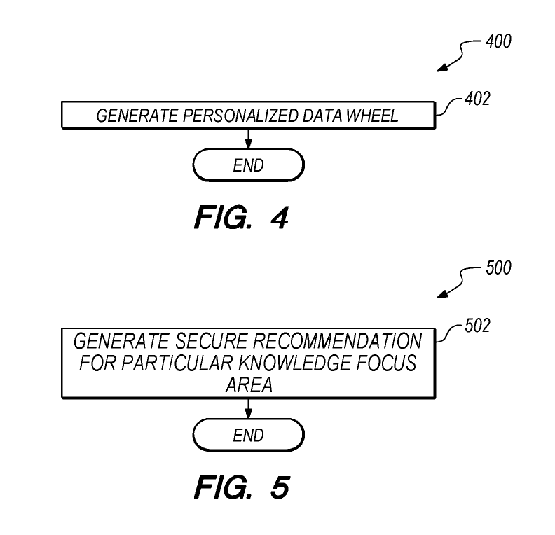

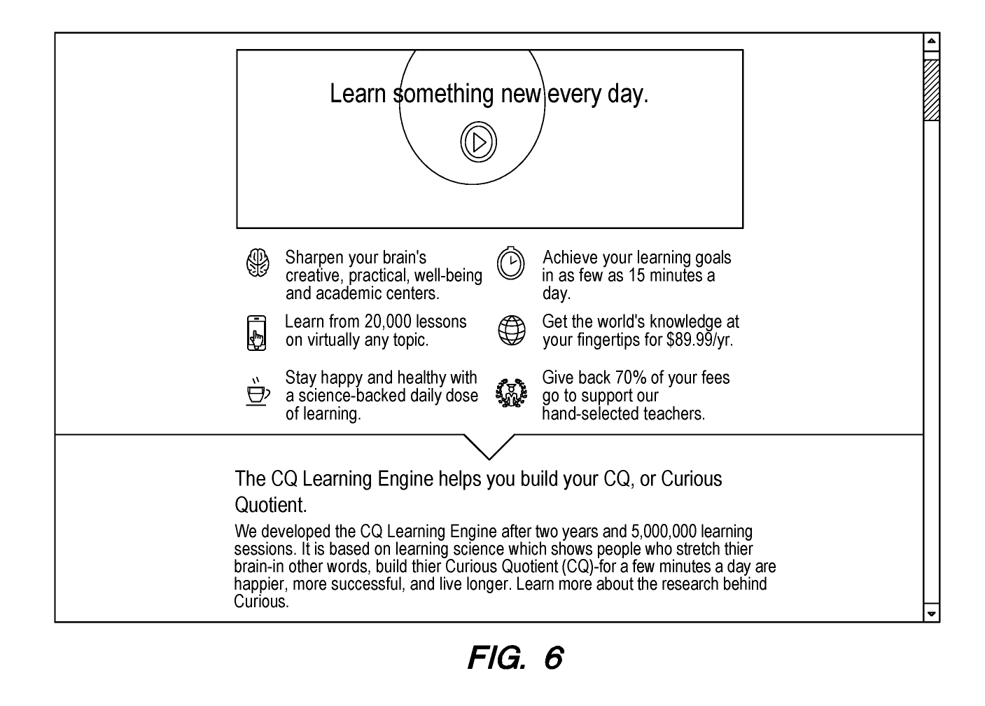

FIG. 4 illustrates a single-step process flow 400 for generating the CQ wheel of the present embodiment.

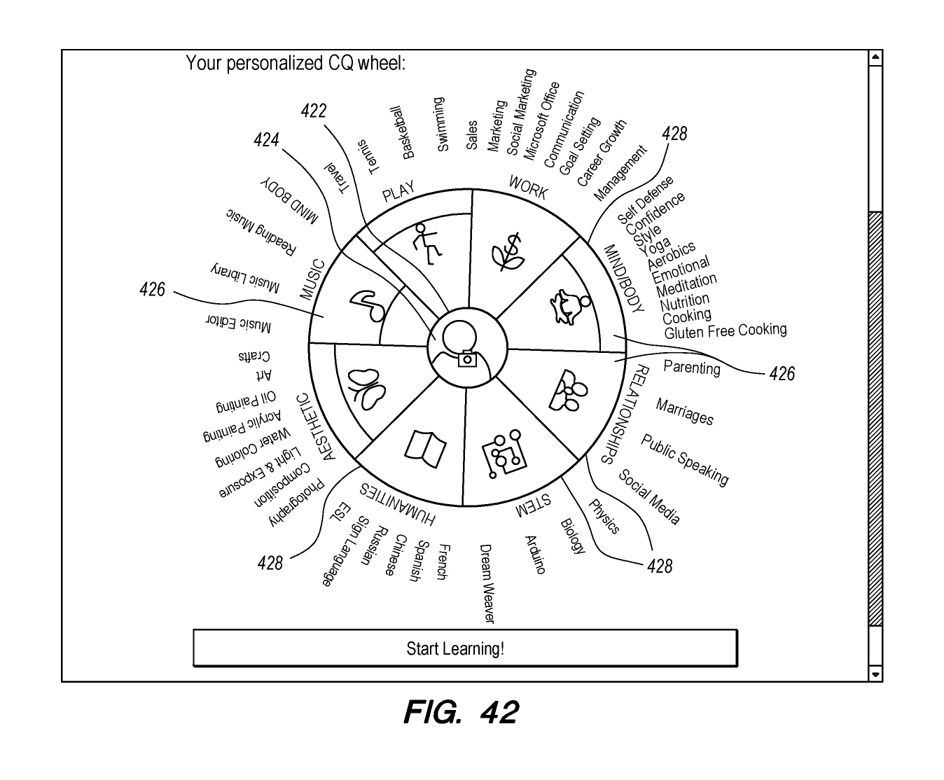

In particular, at step 402, curiosity engine 123 generates a graphical interface for conveying rotatable CQ wheel 400 (of FIG. 42) to knowledge acquirers. In FIG. 42, in one embodiment, as the name implies, rotatable CQ wheel 400 is circular and is configured to rotate around central axis 422. Rotatable CQ wheel 400 is also adapted include a user image 424 located at the wheel center. Rotatable CQ wheel 400 is divided or sectioned into same-sized sectors 426, each bounded by a circumferential arc 428. In this embodiment, there are eight equal sectors that correspond to each subject matter category namely play, work, mind and body, relationships, S.T.E.M., humanities, aesthetic, music and play.

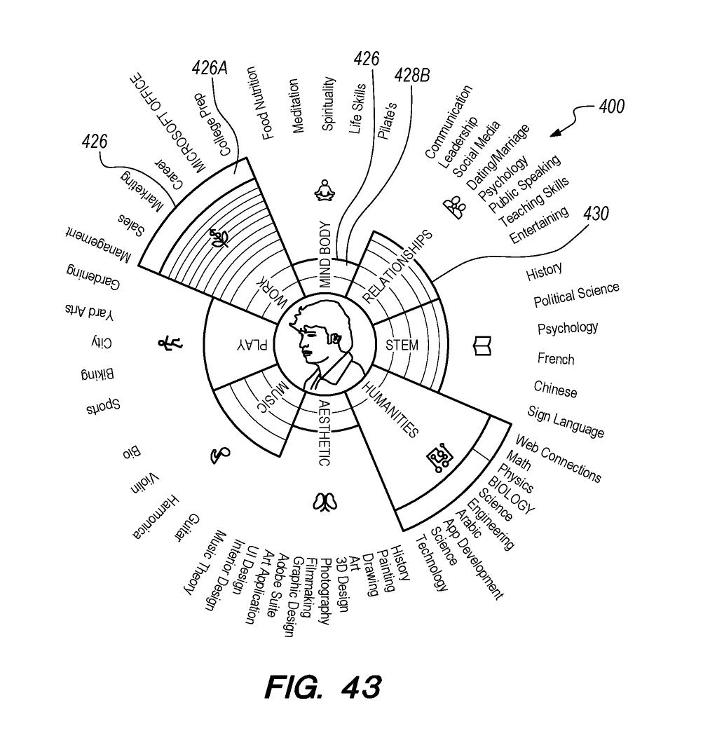

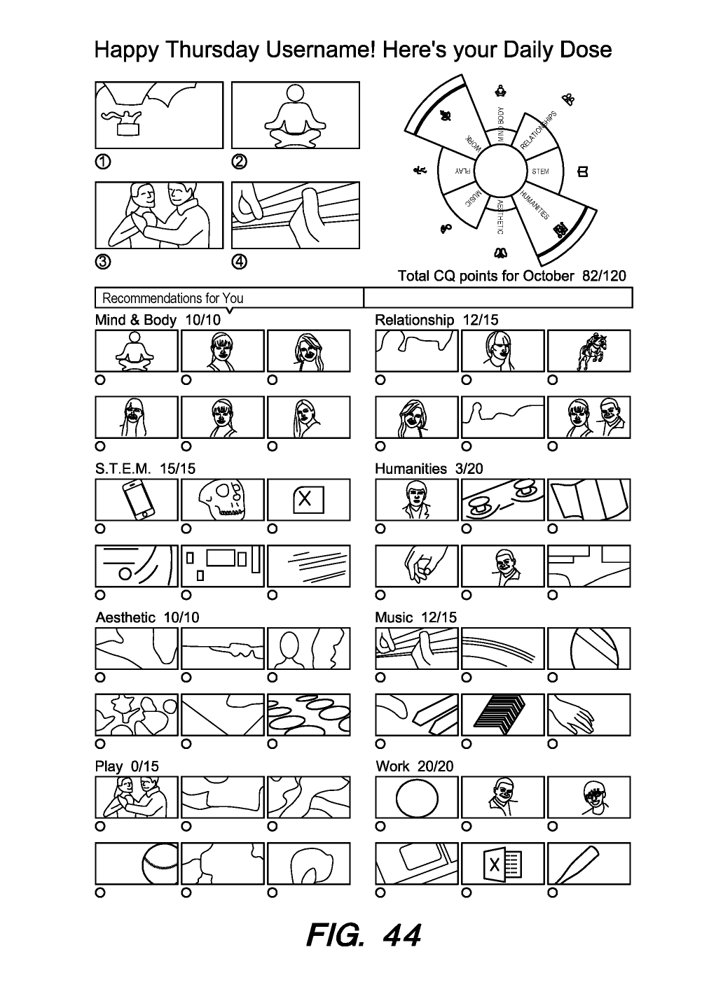

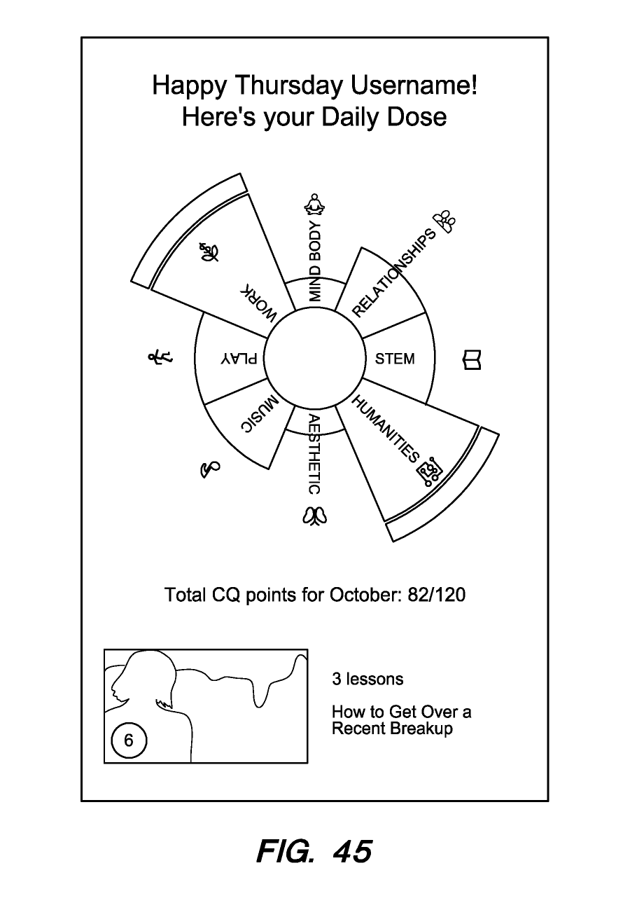

The position of circumferential arc 428 that bounds each sector 426 can vary as illustrated in FIG. 43, which shows an expanded rotatable CQ wheel 400. For example, the position of circumferential arc 428A for sector 424A for work is beyond or above the circumference 430 of rotatable CQ wheel 400 while that of circumferential arc 428B for sector 426B (mind and body) is below the circumference 430 of the wheel. This immediately conveys at a glance that the knowledge acquirer's CQ for work is higher relative to that of mind and body, which CQ is below normal. This embodiment would immediately encourage the knowledge acquirer to build up their CQ where it is deficient.

The position of a circumferential arc is thus based on the weights generated for the knowledge acquirer's interest level, experience, topics of interests and focus area sectors. A higher weighting moves the circumferential arc beyond the circumference of the rotatable wheel and a lower weighting moves the circumferential arc before the circumference of the rotatable wheel. Because the present embodiment uses includes factors such knowledge acquirer's interest level, experience, etc., that vary, a conventional system cannot visually indicate such factors. The present embodiment indicates such factors at a single glance by increasing or decreasing the position of the sector arcs relative to the circumference of the rotatable CQ wheel.

In FIG. 5, curiosity engine 123 generates secure subject matter listings for particular knowledge acquisition focus areas that the knowledge acquirer can use for knowledge acquisition on a daily basis. Specifically, curiosity engine 123 sends a daily dose of knowledge acquisition via email, desktop or mobile application. It provides the best way to build a knowledge acquirer's CQ and achieve monthly knowledge acquisition goals. As a knowledge acquirer uses the listings, the knowledge acquirer earns points for a particular topic area, and those points continue to build up sector 426 until the entirety of the rotatable CQ wheel 400 is filled up. On a monthly basis, a curious quotient is calculated based on how much the knowledge acquirer has obtained divided by how curious the knowledge acquirer is in that period.

The inventors of the present disclosure also recognize the inability of conventional systems to automatically generate course and lesson recommendations on a monthly and daily basis. In one embodiment, algorithms use weights from the weighting generator and the knowledge acquirer's interest level, experience, topics of interests and focus area to provide a list of subject matter content for viewing by knowledge acquirers. In one aspect, a list of subject matter per knowledge acquirer per category that are meant to be seen sequentially is generated. In another embodiment, that list balances factors including whether or not a knowledge acquirer has chosen a focus within a category and which subcategories the knowledge acquirer shows interests in. A second algorithm selects subject matter content to present on a daily basis to knowledge acquirers, giving knowledge acquirers a variety of subject matter content each day, in one embodiment, with a weighting towards content the knowledge acquirer has focused on.

The inventors of the present disclosure also recognize another advantage: presenting a CQ Wheel image customized for each knowledge acquirer based on their interview and preferences (and accumulated CQ scores and goals). In one embodiment, the ‘canvas’ browser dom component is used to draw the wheel.

In a further embodiment, the wheel has a plurality of tiny settings that can be customized (e.g. by a programmer or other person of ordinary skill in the art) depending on how the wheel is to be shown. Those settings are different for each of the pages shown on the wheel on: the assessment page, the dashboard, the category/track pages and the wheel customization pages. The wheel is instantly recognizable in each situation but is actually fairly different looking in each case.

Further yet, the inventors also recognize another advantage of the present disclosure: maintaining the relationship between the assessment questions and answers, CQ goals set by a knowledge acquirer, the rotatable CQ wheel as well as the provided list of subject matter content provided to knowledge acquirers. The embodiments also allow for knowledge acquirers to revisit the assessment process, modify CQ goals, generate CQ wheel output for a revised list of subject matter content to improve CQ goals. In one embodiment, the assessment questions and corresponding assessment answers may be in a spreadsheet that is based in part on a database export subject matter content and categorization. The data may then be converted to a tab delimited file which is then in turn converted into two separate files. Said assessment questions and answers might be available via JSON, for example, to the assessment pages. Subject matter content listing may be converted into a YAML file, for example, for use by curiosity engine 123. When knowledge acquirers responses may be in another JSON blob, for example, in a MYSQL database, for example. The JSON blob are leveraged to create subject matter content lists and generate the graphical interface that conveys the rotatable CQ wheel.

Embodiments of the present invention may also employ CQ workout templates consisting of a cabinet (8-12 quick articles, videos or audio files about subject matter), recipe: two minutes or less content from knowledge acquirer subcategories, 2 5 minute or less content, and personal listings limited to content not previously viewed within a past predetermined period.

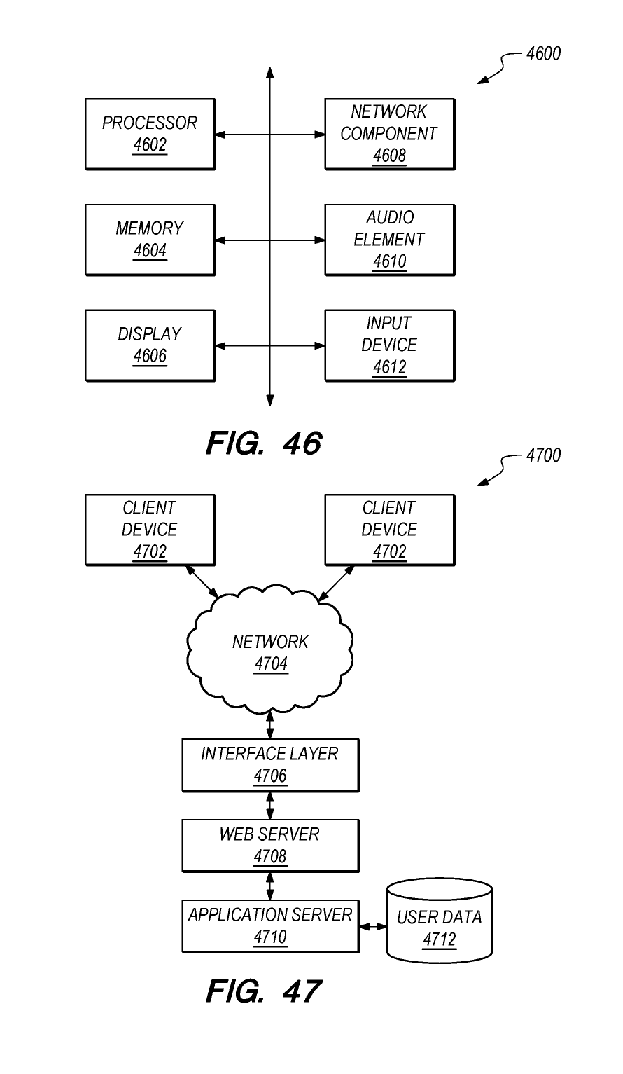

FIG. 46 illustrates one combination of a logical set of general components for an example computing device 4600 that is used in the Curiosity Quotient System and Method of the present disclosure. In this exemplary embodiment, the device comprises a processor 4602 for executing instructions that can be stored in a memory device or element 4604. The device might include various memory types, data storage, or non-transitory computer-readable storage media, such as a first data storage for program instructions for execution by processor 4602, a separate storage for images or data, a removable memory for sharing information with other components, etc. The device may comprise display element 4606, for example LCD (Liquid Crystal Display) or touch screen, although devices such as portable media players might convey information via other means, such as through audio speakers. The device in many embodiments might include at least one input device 4612 that receive input signals from a user. This input element might be a push button, touch pad, touch screen, wheel, joystick, keyboard, mouse, keypad or any other such device or element through which a user can interact or issue commands to the device. In some aspects, a device might exclude button and might be controlled only through visual and audio command, so that the user can control the device without contact with the input device. In other embodiment, the computing device can include one or more network interface elements 4608 for communicating over various networks including Wi-Fi, Bluetooth, RF, wired, or wireless communication systems. The device in many embodiments can communicate with a network, such as the Internet, and may be able to communicate with other such devices. The example device can include one or more audio elements 4610 as well, such as may include one or more speakers for generating audio output and/or one or more microphones for receive audio input, such as voice commands from a user.

FIG. 47 illustrates an example of an environment 4700 in which various embodiments can be implemented. Example environments discussed herein for implement aspects in accordance with various embodiments are primarily Web-based as relate to Web services and cloud computing, but it should be appreciated that, although a Web-based environment is used for purposes of explanation, different environments may be used as appropriate, to implement various embodiments. Client devices 4702 employed with various embodiments can include any appropriate device operable to send and receive request, messages, or information over at least one appropriate network 4704 and convey information back to a user of the device.

Examples of such client devices include personal computers, smart phones, hand held messaging devices, laptop computers, set-top boxes, personal data assistants, electronic book readers, and the like. The network can include any appropriate network, including an intranet, the Internet, a cellular network, a local area network, including an intranet, the Internet, a cellular network, a local area network, or any other such network or combination thereof. Components used for such a system can depend at least in part upon the types of network and/or environment selected. Protocols and components for communicating via such a network are well known and are omitted for brevity. Communication over the network can be enabled by wired or wireless connections, and combination thereof. In at least some embodiments, a request from the client device can be received to an interface layer 4706 associated with a destination address of the request, where the interface layer can include components such as routers, load balancers, application programming interfaces, and the like.

The interface layer can receive the request and direct information for the request to one or more computing resources, such as one or more Web servers 4708 and/or one or more application servers 4710, which can process the request using data in one or more data stores or databases 4712 in at least some embodiments. It should be understood that there can be several application servers, layers or other elements, processes, or components, which may be chained or otherwise configured, which can interact to perform tasks as discussed and suggested herein. As used herein a data store refers to any device or combination of device capable of storing, accessing, and retrieving data, which may include any combination and number of data servers, databases, data storage device, and data storage media in any standard distributed or clustered environment. The data store may be specially programmed to implement embodiments of the present invention thus making such implementation non-generic. A server can include any appropriate hardware and software for integrating with the data store as needed to execute aspects of the one or more applications for the client device, handling a majority of the data access and business logic for an application. The application server provides access control services in cooperation with the data store, and is able to generate content such as text, graphics, audio, and/or video to be transferred to the user, which may be serviced to the user by the Web server in form of HTML, DHTML, XML or another appropriate structured language in the example.

The handling of all requests and responses, as well as the delivery of content between a client device and a resource, can be handled by the Web server. It should be understood that the Web and application servers are not required and are merely example components, as structured code discussed herein can be executed on any appropriate device or host machine as discussed elsewhere herein. Each server typically will include an operating system that provides executable program instructions for the general administration and operation of that server, and typically will include a non-transitory computer readable medium storing instructions that, when executed by a processor of the server, allow the server to perform its intended functions. Suitable implementations for the operating system and general functionality of the servers are known or commercially available, and are readily implemented by persons having ordinary skill in the art, particularly in light of the disclosure herein. However, the servers may be specially programmed and implemented according to the embodiments of the present disclosure to make them non-generic. The environment in one embodiment is a distributed computing environment using several computer systems and components that are interconnected via communication links, using one or more computer networks or direct connections. However, it will be appreciated by those skilled in the art that such a system could operate equally well in a system having fewer or a greater number of components that are illustrated in FIG. 47. Thus, the depictions of various systems and service herein should be taken as being illustrative and not limiting.

Various aspects can be implemented as part of at least one service or Web service. Services such as Web services can communicate using any appropriate type of messaging, such as by using messages in Extensible Markup Language (XML) format and exchanged using an appropriate protocol such as SOAP (derived from the “Simple Object Access Protocol”). Processes provided or executed by such services can be written in any appropriate language such as the Web Services Description Language (WSDL). Using a language such as WSDL allows for functionality such as the automated generation of client-side code in various SOAP frameworks. Various embodiments utilize at least one network that would be familiar to those skilled in the art for supporting communications using any of a variety of commercially available protocols, such TCP/IP. The network can a local area network, a wide area network, a virtual private network, the Internet, an intranet, a cellular network, an extranet, a PSTN, an infrared network, a wireless network, and any combinations thereof. Server(s) may be capable of executing programs or scripts in response requests from user devices, such as by executing one or more scripts or programs written in any programming language, such as JAVA or C++, or any scripting language, such as Perl or Python or combinations thereof. The server(s) may also include any of a number different database servers.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage area network. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements, for example, at least one CPU, as least one input device e.g., a mouse and at least one output device e.g., a display. Such a system may include storage devices such as optical storage device and solid state storage device such as Random Access Memory (“RAM”) or Read Only Memory (ROM). Such devices also can include computer readable storage media reader, a modem, network card. The media can be connected with or configured to receive a computer readably storage medium representing remote, local media. The system will include a number of software applications, modules, services or other elements located within at least one working memory device including an operating system and application programs.

While the above is a complete description of exemplary specific embodiments of the disclosure, additional embodiments are also possible. Thus, the above description should not be taken as limiting the scope of the disclosure, which is defined by the appended claims along with their full scope of equivalents.

I claim:

1. A networked computer system comprising:
a knowledge acquirer database comprising records related to knowledge acquirers, of a plurality of knowledge acquirers, a record including for each knowledge acquirer, an identifier, an age, and a daily amount of knowledge acquisition time commitment;
an assessment database comprising records related to subject matter assessments for a plurality of predetermined subject matter categories, wherein a subject matter assessment record includes for each knowledge acquirer, a plurality of subject matter categories namely
a first subject matter category having at least an answer and a question about the knowledge acquirer's interest level in a subject matter, the knowledge acquirer's experience with the first subject matter category; and topics of the first subject matter that are of interest to the knowledge acquirer; and
a second subject matter category having at least an answer and a question about the knowledge acquirer's interest level in the second subject matter category, the knowledge acquirer's experience with the second subject matter;
and topics of the second subject matter that are of interest to the knowledge acquirer;
a focus assessment database comprising records related to the knowledge acquirer's focus area, wherein a knowledge acquirer's focus area record includes a single selected subtopic area that the knowledge acquirer wishes to focus on, wherein said single selected subtopic area is selected from displayed subtopic areas of the plurality of predetermined subject matter categories;
a weighting generator for generating weights for the knowledge acquirer's interest level, experience, topics of interests and focus area;
a graphical interface for conveying a rotatable wheel display to the knowledge acquirer, wherein the rotatable wheel display is segmented into a plurality of same-sized sectors, each bounded by a circumferential arc of the rotatable wheel, the same-sized sectors including a first sector that corresponds to the first subject matter category and a second even sector that corresponds to the second subject matter category, wherein the position of a circumferential arc is based on the weights generated for the knowledge acquirer's interest level, experience, topics of interests and focus area sectors, wherein a higher weighting moves the circumferential arc beyond the circumference of the rotatable wheel and a lower weighting moves the circumferential arc before the circumference of the rotatable wheel; and
logic for using the weights and the knowledge acquirer's interest level, experience, topics of interests and focus area to provide a list of subject matter content for viewing.

2. The networked computer system of claim 1 wherein the rotatable wheel display includes subtopics selected by a knowledge acquirer displayed along positions corresponding to spokes of the rotatable wheel display.

3. The networked computer system of claim 1 logic for assigning a CQ point value to each subject matter content viewed by the knowledge acquirer.

4. A computer implemented method comprising:
creating records for a user database comprising records related to knowledge acquirers, of a plurality of users, a record including for each user, a user identifier, an age, and a daily amount of knowledge acquirer time commitment;
creating subject matter assessments for an assessment database comprising records related to subject matter assessments for a plurality of predetermined subject matter categories, wherein a subject matter assessment record includes for each knowledge acquirer, a plurality of subject matter categories namely
a first subject matter category having at least an answer and a question about the knowledge acquirer's interest level in a subject matter, the knowledge acquirer's experience with the first subject matter category; and topics of the first subject matter that are of interest to the knowledge acquirer; and
a second subject matter category having at least an answer and a question about the knowledge acquirer's interest level in the second subject matter category, the knowledge acquirer's experience with the second subject matter;
and topics of the second subject matter that are of interest to the knowledge acquirer;
creating knowledge acquirer's focus area assessments for a focus assessment database comprising records related to the knowledge acquirer's focus area, wherein a knowledge acquirer's focus area record includes a single selected subtopic area that the knowledge acquirer wishes to focus on, wherein said single selected subtopic area is selected from displayed subtopic areas of the plurality of predetermined subject matter categories;
generating weights for the knowledge acquirer's interest level, experience, topics of interests and focus area;
presenting a graphical interface for conveying a rotatable wheel display to the knowledge acquirer, wherein the rotatable wheel display is segmented into a plurality of same-sized sectors, each bounded by a circumferential arc of the rotatable wheel, the same-sized sectors including a first sector that corresponds to the first subject matter category and a second even sector that corresponds to the second subject matter category, wherein the position of a circumferential arc is based on the weights generated for the knowledge acquirer's interest level, experience, topics of interests and focus area sectors, wherein a higher weighting moves the circumferential arc beyond the circumference of the rotatable wheel and a lower weighting moves the circumferential arc before the circumference of the rotatable wheel; and
using the weights and the knowledge acquirer's interest level, experience, topics of interests and focus area to provide a list of subject matter content for viewing.

5. The method of claim 4 wherein the rotatable wheel display includes subtopics selected by a knowledge acquirer displayed along positions corresponding to spokes of the rotatable wheel display.

6. The method of claim 4 further comprising for determining how many curiosity quotient point value a subject matter is worth, and assigning said curiosity quotient point value to each subject matter content viewed by the knowledge acquirer.

7. A non-transitory computer readable medium comprising instructions executed by a processor for:
creating records for a user database comprising records related to knowledge acquirers, of a plurality of users, a record including for each user, a user identifier, an age, and a daily amount of knowledge acquirer time commitment;
creating subject matter assessments for an assessment database comprising records related to subject matter assessments for a plurality of predetermined subject matter categories, wherein a subject matter assessment record includes for each knowledge acquirer, a plurality of subject matter categories namely
a first subject matter category having at least an answer and a question about the knowledge acquirer's interest level in a subject matter, the knowledge acquirer's experience with the first subject matter category; and topics of the first subject matter that are of interest to the knowledge acquirer; and
a second subject matter category having at least an answer and a question about the knowledge acquirer's interest level in the second subject matter category, the knowledge acquirer's experience with the second subject matter; and topics of the second subject matter that are of interest to the knowledge acquirer;
creating knowledge acquirer's focus area assessments for a focus assessment database comprising records related to the knowledge acquirer's focus area, wherein a knowledge acquirer's focus area record includes a single selected subtopic area that the knowledge acquirer wishes to focus on, wherein said single selected subtopic area is selected from displayed subtopic areas of the plurality of predetermined subject matter categories;
generating weights for the knowledge acquirer's interest level, experience, topics of interests and focus area;
presenting a graphical interface for conveying a rotatable wheel display to the knowledge acquirer, wherein the rotatable wheel display is segmented into a plurality of same-sized sectors, each bounded by a circumferential arc of the rotatable wheel, the same-sized sectors including a first sector that corresponds to the first subject matter category and a second even sector that corresponds to the second subject matter category, wherein the position of a circumferential arc is based on the weights generated for the knowledge acquirer's interest level, experience, topics of interests and focus area sectors, wherein a higher weighting moves the circumferential arc beyond the circumference of the rotatable wheel and a lower weighting moves the circumferential arc before the circumference of the rotatable wheel; and
using the weights and the knowledge acquirer's interest level, experience, topics of interests and focus area to provide a list of subject matter content for viewing.

8. The non-transitory computer readable medium of claim 7 wherein the rotatable wheel display includes subtopics selected by a knowledge acquirer displayed along positions corresponding to spokes of the rotatable wheel display.

9. The non-transitory computer readable medium of claim 7 further comprising for determining how many curiosity quotient point value a subject matter is worth, and assigning said curiosity quotient point value to each subject matter content viewed by the knowledge acquirer.

10. The system of claim 1 wherein the weighting generator at least in part generates weights based on prior user viewing.

11. The system of claim 1 wherein the weighting generator at least in part generates weights based on whether a focus area is selected.
